(19) United States
(12) Patent Application Publication
(10) Pub. No.: US 2015/0111107 A1
(43) Pub. Date: Apr. 23, 2015

(54) ELECTRODE AND SECONDARY BATTERY, AND MANUFACTURING METHOD THEREOF

(71) Applicant: SEMICONDUCTOR ENERGY LABORATORY CO., LTD., Atsugi-shi (JP)

(72) Inventors: Teppei OGUNI, Atsugi (JP); Minoru TAKAHASHI, Matsumoto (JP); Kai KIMURA, Atsugi (JP)

(21) Appl. No.: 14/519,443

(22) Filed: Oct. 21, 2014

(30) Foreign Application Priority Data
Oct. 22, 2013 (JP) 2013-218885

(51) Int. Cl. H01M 4/02; H01M 4/583; H01M 4/64

(52) U.S. Cl. CPC H01M 4/02; H01M 4/64; H01M 4/583; H01M 2004/021
USPC 429/231.8; 429/209; 429/233

(57) ABSTRACT

To improve the adhesion between a current collector and an electrode active material so as to improve long-term reliability. An electrode is formed in the following manner: an electrode active material (a negative electrode active material or a positive electrode active material) is formed over a base, a conductive film is formed over the electrode active material by a sputtering method, the base and the electrode active material are separated at the interface therebetween, and the electrode active material is made in contact with a current collector. The conductive film has a surface with projections and depressions because the conductive film is formed on the electrode active material containing particles. Accordingly, moderate adhesion can be provided between the conductive film and the current collector, with which stress at the interface between the conductive film and the current collector can be reduced while conductivity is maintained.

### BACKGROUND OF THE INVENTION

1. Field of the Invention

One embodiment of the present invention relates to an object, a method, and a manufacturing method. In addition, one embodiment of the present invention relates to a process, a machine, manufacture, and a composition of matter. In particular, one embodiment of the present invention relates to a semiconductor device, a display device, a light-emitting device, a lighting device, and a power storage device, or a driving method and manufacturing method thereof. In particular, one embodiment of the present invention relates to a structure of a secondary battery and a method for manufacturing the secondary battery. In particular, the present invention relates to an electrode of a lithium-ion secondary battery.

2. Description of the Related Art

Examples of the secondary battery include a nickel-metal hydride battery, a lead secondary battery, and a lithium-ion secondary battery.

Such secondary batteries are used as power sources in portable information terminals typified by mobile phones. In particular, lithium-ion secondary batteries have been actively researched and developed because capacity thereof can be increased and size thereof can be reduced.

Patent Document 1 discloses that a multilayer graphene flake or multilayer graphene flakes are wrapped around positive electrode active materials or negative electrode active materials to prevent dispersion of the positive electrode active materials or the negative electrode active materials and collapse of a positive electrode active material layer or a negative electrode active material layer. Multilayer graphene can maintain the adhesion to the positive electrode active materials or the negative electrode active materials.

To improve the design aesthetics and functionality of portable information terminals and other devices, flexible devices have been under development, and lithium-ion secondary batteries that can be mounted on flexible devices are needed.

### REFERENCE

### Patent Document

### [Patent Document 1] Japanese Published Patent Application No. 2013-028526

### SUMMARY OF THE INVENTION

In a lithium-ion secondary battery, a carbon material is typically used as a negative electrode active material, and lithium metal complex oxide is typically used as a positive electrode active material.

When an electrode layer is formed over a current collector such as a metal foil, slurry in which fine particles of a positive electrode active material or a negative electrode active material are suspended in a solvent (suspension containing a binder and the like) is applied to the metal foil and dried. For example, in the case of forming a negative electrode, a solution containing carbon particles is applied to a copper foil or an aluminum foil and dried; moreover, this is pressed if necessary. The negative electrode formed in such a manner, a separator, a positive electrode containing a positive electrode active material such as lithium iron phosphate, and an electrolyte solution are assembled to fabricate a lithium-ion secondary battery.

The type of deterioration of the lithium-ion secondary battery can be broadly classified as and expressed by the terms “calendar life” and “cycle life”. The term “calendar life” is used to express deterioration due to an electrochemical change caused by charging a lithium-ion secondary battery at high temperature even after the lithium-ion secondary battery is fully charged. The term “cycle life” is used to express deterioration due to an electrochemical change or a physical change of a lithium-ion secondary battery caused by repeating charge and discharge.

Some factors influence the deterioration expressed by the terms “cycle life” and “calendar life”.

For example, a binder influences the deterioration. Typically, an organic material such as polyvinylidene fluoride is used as the binder. Note that the adhesion of a metal foil such as a copper foil or an aluminum foil (a base) to polyvinylidene fluoride (the binder) is not sufficient at the interface between the metal foil and the binder. When used by itself, the binder is a cause of the internal resistance of a battery. Therefore, the used amount of the binder is preferably small.

Another factor that influences the deterioration is carbon particles. Surfaces of the carbon particles are extremely water repellent. An area of contact between a metal foil and the carbon particles is small, which indicates that the metal foil and the carbon particles are in point contact with each other; therefore, it is difficult to ensure sufficient adhesion. Furthermore, it is known that the carbon particles have a volume change by intercalation and deintercalation of lithium (e.g., approximately 10% volume change in the case of graphite), in which case stress is generated at the interface between a current collector and the carbon particles that are electrode active materials. For these reasons, when a lithium-ion secondary battery is charged and discharged repeatedly, the adhesion of the metal foil to a negative electrode active material is decreased, so that the negative electrode active material is separated from the metal foil, leading to a decrease in charge and discharge characteristics, short life of the lithium-ion secondary battery, or a decrease in rate characteristics. In addition, in the case of a lithium-ion secondary battery that can be changed in shape, i.e., in the case of a flexible lithium-ion secondary battery, stress is generated at the interface of a negative electrode active material with a metal foil when the shape of the battery is changed. As a result, the negative electrode active material is separated from the metal foil, which leads the above problems to be significant.

An object of one embodiment of the present invention is to provide a secondary battery that achieves an improvement in the adhesion or to a reduction in stress between a metal foil, which is a current collector, and a negative electrode active material or a positive electrode active material for long-term reliability or improved rate characteristics.

Another object of one embodiment of the present invention is to provide a lithium-ion secondary battery with a novel electrode structure. Another object of one embodiment of the present invention is to provide a novel electrode. Another object of one embodiment of the present invention is to provide a novel power storage device.

Another object of one embodiment of the present invention is to provide a secondary battery that can be changed in shape, i.e., a flexible secondary battery, with a novel electrode structure capable of withstanding change in shape.

Note that the description of these objects does not disturb the existence of other objects. In one embodiment of the present invention, there is no need to achieve all the objects. Other objects will be apparent from and can be derived from the description of the specification, the drawings, the claims, and the like.

One embodiment of the invention disclosed in this specification is a method for forming an electrode, including the steps of applying slurry containing a plurality of electrode active material particles to a base; drying the slurry; forming a conductive film over the electrode active material particles; separating the base from the electrode active material particles; and making a current collector in contact with the conductive film for electrical connection.

One embodiment of the invention disclosed in this specification is an electrode including at least a current collector, a conductive film over the current collector, and an electrode active material layer over the conductive film. The electrode active material layer contains a plurality of particles. A surface of the conductive film in contact with the current collector is rougher than a surface of the current collector in contact with the conductive film.

One embodiment of the invention disclosed in this specification is an electrode including at least a current collector, a conductive film over the current collector, and an electrode active material layer over the conductive film. The electrode active material layer contains a plurality of particles. The area of a region that is in the conductive film and in contact with the plurality of particles is larger than the area of a region that is in the conductive film and in contact with the current collector.

One embodiment of the invention disclosed in this specification is an electrode including at least a current collector, a conductive film over the current collector, and an electrode active material layer over the conductive film. The electrode active material layer contains a plurality of particles. A surface of the conductive film in contact with the current collector is rougher than a surface of the current collector in contact with the conductive film. The conductive film is thinner than the electrode active material layer.

One embodiment of the invention disclosed in this specification is an electrode including at least a current collector, a conductive film over the current collector, and an electrode active material layer over the conductive film. The electrode active material layer contains a plurality of particles. The area of a region that is in the conductive film and in contact with the plurality of particles is larger than the area of a region that is in the conductive film and in contact with the current collector. The conductive film is thinner than the electrode active material layer.

In the electrode of one embodiment of the present invention, an aluminum foil or a copper foil can be used for the current collector. Furthermore, lithium iron phosphate or at least one of carbon and silicon can be used for the plurality of particles contained in the electrode active material layer. In addition, at least one of aluminum, titanium, copper, and nickel can be used for the conductive film.

In the electrode of one embodiment of the present invention, the conductive film can be formed by a sputtering method, a CVD method, or an evaporation method. The conductive film formed by such a method may have a shape that reflects the particles contained in the electrode active material layer.

In the electrode of one embodiment of the present invention, the electrode active material layer may further contain insulating particles and include a first region and a second region. The insulating particles may be contained in the first region and not in the second region. In the electrode active material layer, the first region may be thicker than the second region. In the electrode of one embodiment of the present invention, a surface of the electrode active material layer in contact with the conductive film may be rougher than the opposite surface of the electrode active material layer. In the electrode of one embodiment of the present invention, the conductive film and the current collector can slide past each other.

One embodiment of the present invention is a secondary battery including the electrode of one embodiment of the present invention, an electrolyte solution, and a counter electrode facing the electrode. The secondary battery of one embodiment of the present invention may be a lithium-ion secondary battery. The secondary battery of one embodiment of the present invention may be a flexible secondary battery.

In the case where particles are used for an electrode active material and provided on a surface of a flat base in one embodiment of the present invention, for example, a space is formed between the particles. A conductive film formed by a sputtering method, a CVD method, or an evaporation method, for example, fills at least part of the space between the particles. When a layer containing a plurality of particles is referred to as an electrode active material layer, a plurality of projections and a plurality of depressions are provided on a surface of the electrode active material layer. In such a case, the conductive film formed by a sputtering method, a CVD method, or an evaporation method fills the plurality of depressions on the surface of the electrode active material layer, or planarizes the plurality of projections on the surface of the electrode active material layer. Note that the surface with the projections and the depressions is not completely flattened.

The conductive film formed by a sputtering method, a CVD method, or an evaporation method maintains the adhesion between particles in contact with the conductive film. It is known that particles contained in an electrode active material layer have a volume change by intercalation and deintercalation of ions (e.g., lithium in a lithium-ion secondary battery). The volume change of the particles causes stress to the electrode active material layer, leading to deterioration such as shear. However, the conductive film that fills the depressions on the surface of the electrode active material layer reduces the stress and maintains the adhesion between the particles. Also in the case where flow stress is applied to the electrode by an external force, the conductive film that fills the depressions on the surface of the electrode active material layer reduces the stress; thus, the adhesion between the particles in the electrode active material layer is more likely to be maintained in comparison with the case of no conductive film. This means that the conductive film that fills the depressions on the surface of the electrode active material layer functions as a buffer layer between the current collector and the electrode active material.

In addition, the conductive film formed between the electrode active material layer and the current collector by a sputtering method, a CVD method, or an evaporation method reduces stress at the interface between the conductive film and the current collector; thus, separation of the electrode active material layer due to an external force or the volume change of the particles in the electrode active material layer can be prevented. Since the surface of the conductive film is a rough surface reflecting the projections and the depressions on the surface of the electrode active material layer in one embodiment of the present invention, the area of a region where the conductive film is in contact with the current collector is small as compared to the case where the conductive film is directly formed on the surface of the current collector by a general method. Note that in the case where stress is generated at the interface between the current collector and the conductive film that is directly formed on the surface of the current collector, there is little room for reducing the stress; as a result, separation at the interface easily occurs. In contrast, in the case where stress is generated at the interface between the current collector and the conductive film that has a surface with projections and depressions, the stress can be reduced because the interface is not completely fixed. The current collector and the conductive film can slide past each other with conductivity to be released from the stress.

One embodiment of the present invention does not exclude the case where the conductive film is directly formed on the surface of the current collector. Even when the conductive film is directly formed on the surface of the current collector, the electrode of one embodiment of the present invention can be formed as long as the conductive film has a suitable shape or characteristics. In the electrode of one embodiment of the present invention, the current collector and the conductive film are moderately adhered to each other so that the stress can be reduced while conductivity is maintained. The electrode of one embodiment of the present invention includes a conductive film that reflects the particles contained in the electrode active material layer. Accordingly, a surface of the conductive film on the side in contact with the current collector is not flat and is rougher than a surface of the current collector on the side in contact with the conductive film. In addition, the area of a region where the conductive film is in contact with the particles contained in the electrode active material layer is larger than the area of a region where the conductive film is in contact with the current collector.

In the method for forming an electrode of one embodiment of the present invention, a material that meets the following requirements can be used for the base: the conductive film can be formed over the material by a sputtering method, a CVD method, or an evaporation method; and the material hardly reacts with a solvent containing the electrode active material. For example, a plastic film and a metal foil (e.g., a titanium foil and a copper foil) can be used. Furthermore, to separate the electrode active material from the base easily in the later step, a silicon oxide film or a fluororesin film (e.g., a polytetrafluoroethylene film) may be provided on a surface of the plastic film or a surface of the metal foil.

As the electrode active material, carbon particles are typically used; for example, natural graphite (e.g., scale-like and spherical) and artificial graphite can be used. Note that carbon particles whose surfaces are partly covered with a silicon oxide film may be used as the electrode active material, for example.

In this specification, there is no particular limitation on the electrode active material as long as lithium ions can electrochemically occluded into and released from the negative electrode active material.

Note that the conductive film is not in contact with all the electrode active materials except for the case where the number of the electrode active material particles is small. Therefore, a binder may be used to strengthen the adhesion between the electrode active materials, or a conductive additive may be used to increase electrical conductivity between the electrode active materials or between the electrode active material and the current collector.

The adhesion between the electrode active materials can be partly strengthened with the use of the conductive film; consequently, the used amount of a binder can be smaller than that in the case where the conductive film is not used.

In addition, to strengthen the adhesion between the electrode active materials, a plurality of graphene flakes may be formed in such a way as to wrap or coat a plurality of electrode active material particles. Graphene is a carbon material having a crystal structure in which hexagonal skeletons of carbon are spread in a planar form and is one atomic plane extracted from graphite crystals. Due to its electrical, mechanical, or chemical characteristics which are surprisingly excellent, the graphene has been expected to be used for a variety of fields of, for example, field-effect transistors with high mobility, highly sensitive sensors, highly-efficient solar cells, and next-generation transparent conductive films and has attracted a great deal of attention. When the plurality of graphene flakes are formed, the conductive film formed by a sputtering method, a CVD method, or an evaporation method strengthens the adhesion between graphene and the electrode active material.

In this specification, the term “slurry” refers to suspension in which an electrode active material is suspended in a solvent, and suspension which contains not just the solvent and the electrode active material but other additives such as a binder, a conductive additive, and graphene oxide is also referred to as “slurry”.

In the method for forming an electrode of one embodiment of the present invention, the slurry may contain insulating particles, one of which is larger than one of the plurality of electrode active material particles. In the electrode formed by the method of one embodiment of the present invention, the electrode active material layer further contains insulating particles and includes a first region and a second region. The insulating particles are contained in the first region and not in the second region. In the electrode active material layer, the thickness of the first region is larger than the thickness of the second region.

In the case where the electrode active material layer contains insulating particles one of which is larger than one of the electrode active material particles, the thickness of the electrode active material layer is affected by the sizes of the insulating particles, which means that the thickness of the electrode active material layer depends on the insulating particles. Accordingly, in the electrode active material layer, the thickness of a region containing the insulating particles is larger than that of a region not containing the insulating particles. In that case, the electrode active material layer can have room in the region not containing the insulating particles, and stress due to expansion and contraction of the electrode active material particles or the change in shape of the electrode can be reduced or absorbed. As a result, the separation of the electrode active material layer is less likely to occur; thus, a secondary battery including the electrode can have the long-term reliability or improved rate characteristics and can withstand the change in shape.

The secondary battery of one embodiment of the present invention achieves an improvement in the adhesion or a reduction in stress between a metal foil, which is a current collector, and an electrode active material for long-term reliability or improved rate characteristics. One embodiment of the present invention can provide a lithium-ion secondary battery with a novel electrode structure. One embodiment of the present invention can provide a novel electrode. One embodiment of the present invention can provide a novel power storage device.

One embodiment of the present invention can provide a secondary battery that can be changed in shape, i.e., a flexible secondary battery, with a novel electrode structure capable of withstanding change in shape.

Note that the description of these effects does not disturb the existence of other effects. One embodiment of the present invention does not necessarily have all the effects. Other effects will be apparent from and can be derived from the description of the specification, the drawings, the claims, and the like.

### BRIEF DESCRIPTION OF THE DRAWINGS

FIGS. 1A to 1E are cross-sectional views illustrating steps of one embodiment of the present invention.

FIG. 2 is a cross-sectional SEM image of one embodiment of the present invention.

FIGS. 3A to 3E are cross-sectional views illustrating steps of one embodiment of the present invention.

FIGS. 4A to 4C are cross-sectional views illustrating steps of one embodiment of the present invention.

FIGS. 5A to 5C illustrate a coin-type secondary battery.

FIG. 6 illustrates a laminated secondary battery.

FIGS. 7A and 7B illustrate cylindrical secondary batteries.

FIGS. 8A to 8E illustrate electronic devices.

FIG. 9 is a schematic cross-sectional view of one embodiment of the present invention.

FIGS. 10A to 10C are cross-sectional views illustrating steps of one embodiment of the present invention.

FIG. 11 illustrates an electronic device.

FIGS. 12A and 12B show results of cycle tests.

FIG. 13A shows results of cycle tests and FIG. 13B shows capacity retention rate.

FIGS. 14A and 14B each illustrate an example of a power storage device.

FIGS. 15A1, 15A2, 15B1, and 15B2 each illustrate an example of a power storage device.

FIGS. 16A and 16B each illustrate an example of a power storage device.

FIGS. 17A and 17B each illustrate an example of a power storage device.

FIG. 18 illustrates an example of a power storage device.

FIG. 19 is a cross-sectional SEM image of one embodiment of the present invention.

### DETAILED DESCRIPTION OF THE INVENTION

Embodiments and an example of the present invention will be described below in detail with reference to the drawings. Note that the present invention is not limited to the description below, and it is easily understood by those skilled in the art that modes and details disclosed herein can be modified in various ways. In addition, the present invention should not be construed as being limited to the description in the following embodiments and example.

### Embodiment 1

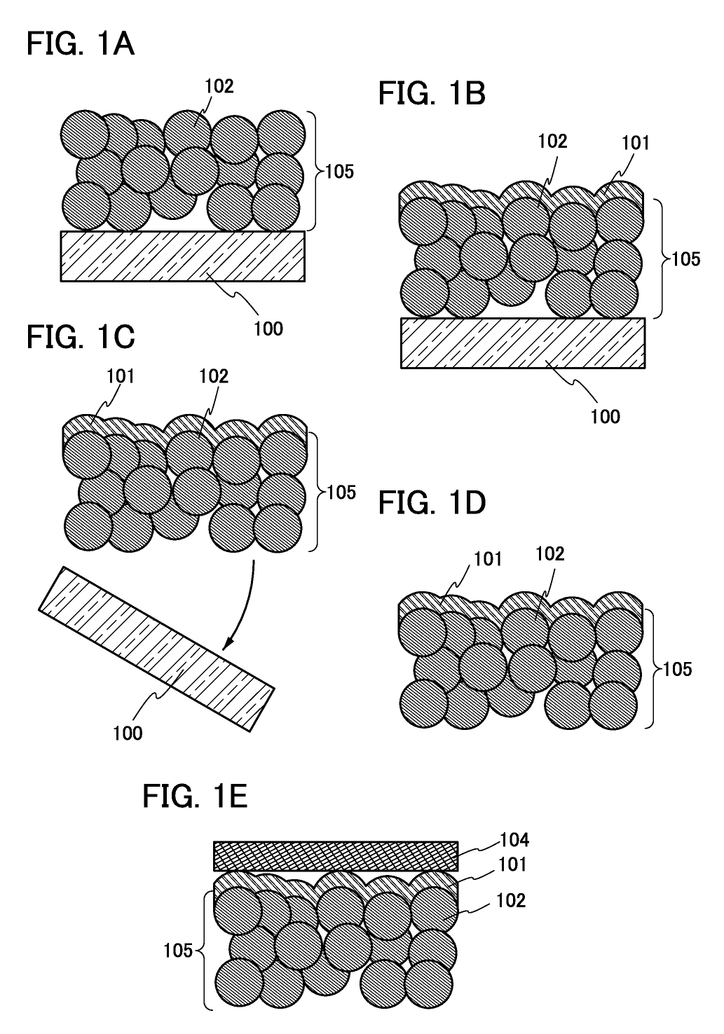

Description is given below of a method for forming an electrode of a lithium-ion secondary battery of one embodiment of the present invention with reference to FIGS. 1A to 1E.

First, slurry containing an electrode active material 102 is applied to a base 100 and dried. FIG. 1A is a schematic cross-sectional view of an electrode active material layer 105 formed as follows: the slurry containing the electrode active material 102 is applied to the base 100 and dried.

Note that in FIG. 1A, the electrode active material 102 is an electrode active material made of secondary particles having an average particle diameter and a particle size distribution. For this reason, the electrode active material 102 is schematically illustrated as circles in FIG. 1A; however, the shape of the electrode active material 102 is not limited to this shape. In this embodiment, steps of forming a negative electrode will be described below.

The electrode active material 102 can be used as a positive electrode active material or a negative electrode active material. In the case where the electrode active material 102 is used as the negative electrode active material, for example, a carbon-based material such as graphite, graphitizing carbon (soft carbon), non-graphitizing carbon (hard carbon), a carbon nanotube, graphene, or carbon black can be used. Examples of the graphite include artificial graphite such as meso-carbon microbeads (MCMB), coke-based artificial graphite, or pitch-based artificial graphite and natural graphite such as spherical natural graphite. In addition, the shape of the graphite is a flaky shape or a spherical shape, for example.

In addition to the carbon-based materials, a material that enables charge-discharge reactions by an alloying reaction and a dealloying reaction with lithium can be used for the negative electrode active material. For example, a material including at least one of Ga, Si, Al, Ge, Sn, Pb, Sb, Bi, Ag, Zn, Cd, In, and the like can be used. Such elements have higher capacity than carbon. In particular, silicon is preferred because it has a high theoretical capacity of 4200 mAh/g. Examples of an alloy-based material including such elements are Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), and molybdenum oxide (MoO₂) can be used.

Still alternatively, for the negative electrode active material, Li₃₋ₓMₓN (M is Co, Ni, or Cu) with a Li₃N structure, which is a nitride including lithium and a transition metal, can be used. For example, Li_{2.6}Co_{0.4}N₃ is preferable because of its high charge-discharge capacity (900 mAh/g, 1890 mAh/cm³).

When a nitride including lithium and a transition metal are used, lithium ions are included in the negative electrode active material; thus, the negative electrode active material can be used in combination with a material for a positive electrode active material that does not include lithium ions, such as V₂O₅ or Cr₃O₈. In the case of using a material including lithium ions for a positive electrode active material, the nitride including lithium and a transition metal can be used for the negative electrode active material by extracting the lithium ions included in the positive electrode active material in advance.

Alternatively, a material that causes a conversion reaction can be used for the negative electrode active material. For example, a transition metal oxide which does not cause an alloying reaction with lithium, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

The particle diameter of the electrode active material is preferably greater than or equal to 50 nm and less than or equal to 100 μm.

Examples of a conductive additive of an electrode include acetylene black (AB), graphite (black lead) particles, carbon nanotubes, graphene, and fullerene.

A network for electrical conduction can be formed in the electrode by the conductive additive. The conductive additive also allows maintaining of a path for electrical conduction between the electrode active materials. The addition of the conductive additive to the electrode active material layer increases the electrical conductivity of the electrode active material layer.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the electrode active material layer is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the electrode active material layer is preferably greater than or equal to 1 wt % and less than or equal to 10 wt %, more preferably greater than or equal to 1 wt % and less than or equal to 5 wt %.

In the case where the electrode active material layer is formed by a coating method, the electrode active material, the binder, and the conductive additive are mixed to form slurry, and the slurry is applied to the base 100 and dried. Pressing may be performed after the drying if necessary.

A material that hardly reacts with a solvent contained in the slurry and has low adhesion to the electrode active material 102 is used for the base 100. Furthermore, the material of the base 100 can be deposited by a sputtering method, a CVD method, or an evaporation method in a vacuum in the later step. As the base 100, a polyimide film, a separator, a glass substrate, and a copper foil can be used. A fluororesin film or a silicon oxide film may be formed on the surface of the polyimide film, the glass substrate, or the copper foil.

Next, as illustrated in FIG. 1B, a conductive film 101 is formed over the electrode active material 102 by a sputtering method, a CVD method, or an evaporation method. For the conductive film 101, aluminum, titanium, copper, or nickel can be used. As the conductive film 101, for example, a titanium film with a thickness greater than or equal to 1 μm, here, a 3-μm-thick titanium film, is formed by a sputtering method under the following conditions: the substrate temperature is room temperature, the pressure is 0.3 Pa, and the flow rate of argon is 7.5 sccm. Note that the case where graphite is used for the electrode active material 102 over which the conductive film 101 is formed is described as an example.

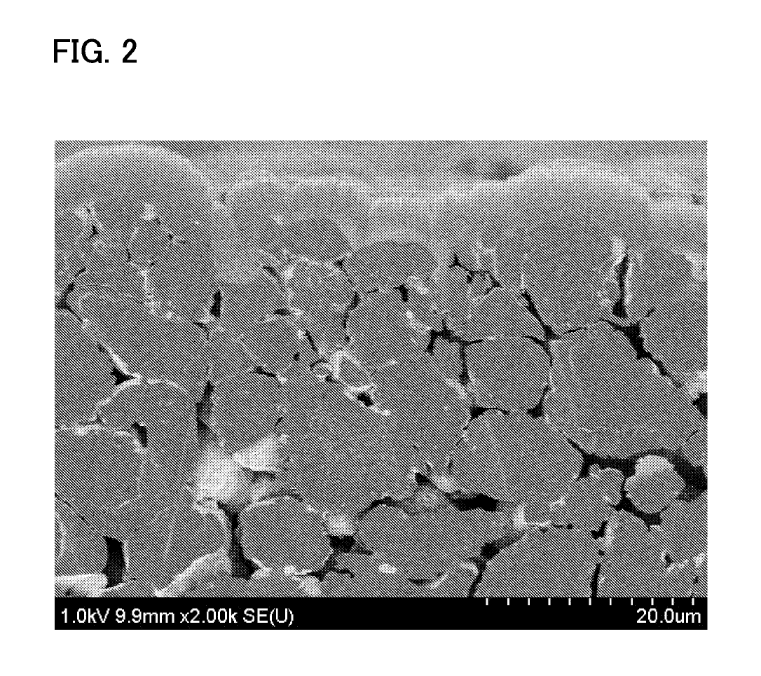

FIG. 2 is a photograph showing an example of a cross section of the electrode active material layer, which is observed with a scanning electron microscope (SEM), at the stage of FIG. 1B. In FIG. 2, an interface between the conductive film 101 and the electrode active material 102 is observed and part of a surface of graphite is found to be in contact with the titanium film. FIG. 2 also shows that a surface of the conductive film is rough and not flat because the surface reflects the surface of graphite and has projections and depressions.

In FIG. 2, the conductive film fills at least part of a space between the particles in the electrode active material. The conductive film that partly fills the space fixes the particles in the electrode active material to each other or strengthens the fixation between the particles in the electrode active material.

Next, as illustrated in FIG. 1C, the base 100 and the electrode active material layer 105 are separated at the interface therebetween. The low adhesion between the base 100 and the electrode active material layer 105 is preferable to the separation; however, there is no problem in separating the electrode active material layer 105 from the base 100 with part of the electrode active material layer 105 remaining on a surface of the base 100.

FIG. 1D illustrates the state after the separation. When the structure in FIG. 1D has enough mechanical strength, the structure can be used as the electrode. In this case, a film with high conductivity is used as the conductive film 101 because the conductive film 101 can serve as a current collector.

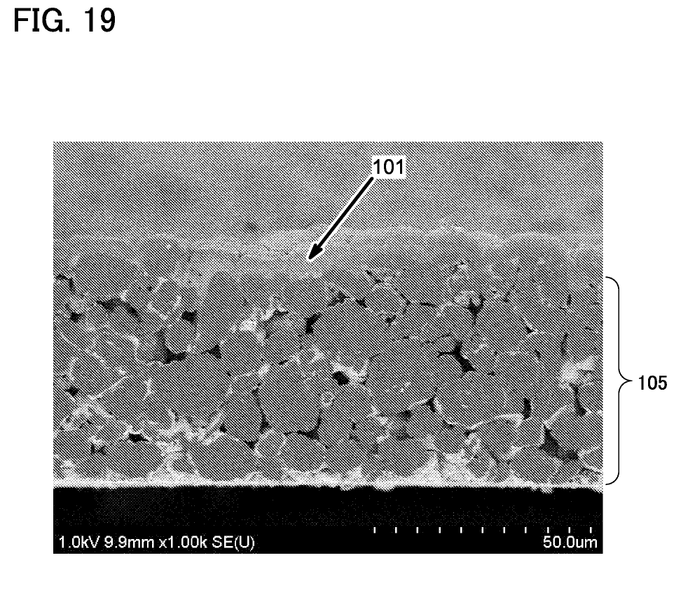

FIG. 19 is a photograph showing an example of a cross section of the active material layer, which is observed with a SEM, at the stage of FIG. 1D. FIG. 19 shows that the electrode active material layer 105 and the conductive film 101 maintain their shapes even though the base 100 is separated.

FIG. 19 also shows that a surface of the electrode active material layer 105 in contact with the conductive film 101 is rough as described above; meanwhile, the opposite surface of the electrode active material layer 105 is flatter than the surface in contact with the conductive film 101. This is because the electrode active material layer 105 is formed over the base 100 and thus reflects the top surface of the base 100. The top surface of the base 100 is not particularly limited but is preferably flat so that the electrode active material layer 105 is easily separated. When the top surface of the base 100 is flat, the surface of the electrode active material layer 105 in contact with the conductive film 101 preferably becomes rougher than the opposite surface, i.e., a surface which is in contact with the base 100 before the separation.

Next, as illustrated in FIG. 1E, the conductive film 101 is electrically connected to a current collector 104. Since the conductive film 101 has high conductivity, sufficient electrical conduction can be obtained only by placing the conductive film 101 on the current collector 104 without using an adhesive or the like.

Note that the current collector 104 can be formed using a highly conductive material which is not alloyed with a carrier ion such as a lithium ion, e.g., a metal typified by stainless steel, gold, platinum, zinc, iron, copper, aluminum, titanium, tantalum and an alloy thereof. Alternatively, an aluminum alloy to which an element that improves heat resistance, such as silicon, titanium, neodymium, scandium, and molybdenum, is added can be used. Still alternatively, a metal element that forms silicide by reacting with silicon can be used. Examples of the metal element that forms silicide by reacting with silicon include zirconium, titanium, hafnium, vanadium, niobium, tantalum, chromium, molybdenum, tungsten, cobalt, and nickel. The current collector 104 can have, for example, a foil-like shape, a plate-like shape (sheet-like shape), a net-like shape, a cylindrical shape, a coil shape, a punching-metal shape, and an expanded-metal shape, as appropriate. The current collector 104 preferably has a thickness of greater than or equal to 5 μm and less than or equal to 30 μm.

Through the above steps, the electrode of the lithium-ion secondary battery can be formed.

The conductive film 101 formed by a sputtering method, a CVD method, or an evaporation method can provide moderate adhesion between the current collector 104 and the electrode active material 102, with which stress can be reduced while conductivity is maintained. When the conductive film 101 is used as a buffer layer, the lithium-ion secondary battery including the electrode can have improved reliability such as rate characteristics. Such an electrode can be used as a flexible electrode and thus can be used in a flexible secondary battery.

Although the case where one embodiment of the present invention is used in a battery, as an example of a power storage device, is described in this embodiment, one embodiment of the present invention is not limited thereto. For example, one embodiment of the present invention can be used in a capacitor. In that case, for example, a lithium ion capacitor can be formed using the negative electrode described in this embodiment and an electric double layer positive electrode.

This embodiment can be freely combined with any of the other embodiments.

### Embodiment 2

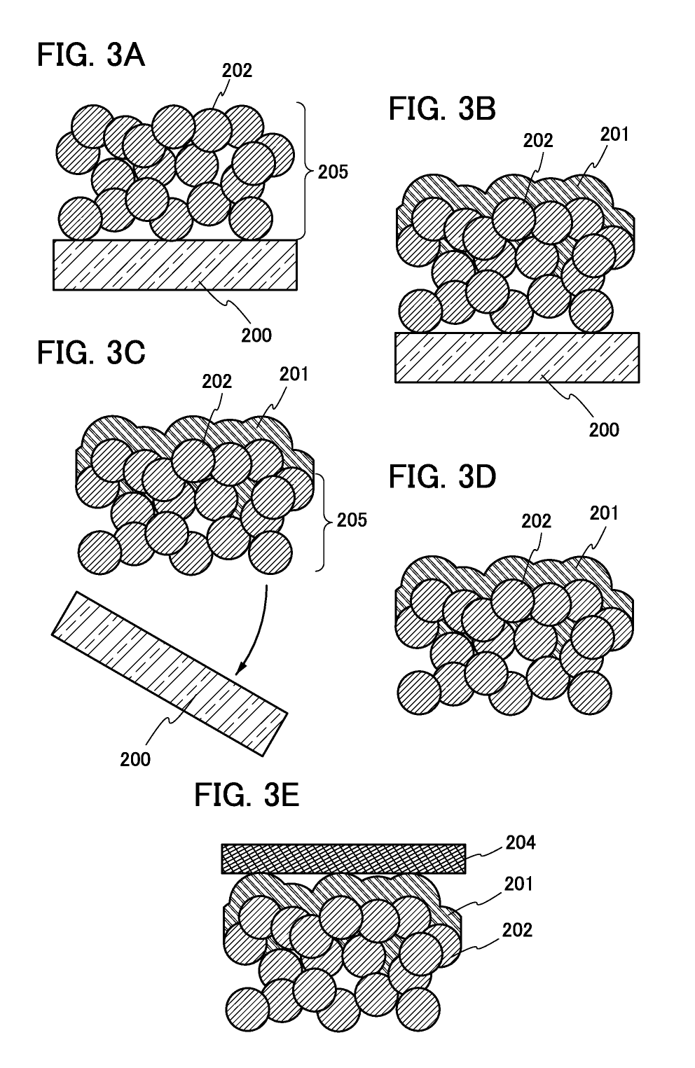

Description is given below of a method for forming an electrode of a lithium-ion secondary battery of another embodiment of the present invention with reference to FIGS. 3A to 3E.

First, slurry containing an electrode active material 202 is applied to a base 200 and dried, so that an electrode active material layer 205 is formed. As the base 200, a polyimide film tape is used, for example. FIG. 3A is a schematic cross-sectional view of the electrode active material layer 205 formed as follows: the slurry containing the electrode active material 202 is applied to the base 200 and dried.

In FIG. 3A, the electrode active material 202 is an electrode active material made of secondary particles having an average particle diameter and a particle size distribution. For this reason, the electrode active material 202 is schematically illustrated as circles in FIG. 3A; however, the shape of the electrode active material 202 is not limited to this shape.

A conductive film 201 is formed as illustrated in FIG. 3B. The conductive film 201 can be formed by, for example, a sputtering method, a CVD method, or an evaporation method.

As illustrated in FIG. 3B, the conductive film 201 fixes adjacent particles to each other in the electrode active material 202. Furthermore, as illustrated in FIG. 3B, the conductive film 201 fills at least part of a space between the particles in the electrode active material 202. FIG. 3B also illustrates that a surface of the conductive film 201 is rough and not flat because the surface reflects the particles in the electrode active material 202.

Then, as illustrated in FIG. 3C, the base 200 that is a polyimide film tape is separated from the electrode active material layer 205.

Through the above steps, the electrode of a lithium-ion secondary battery illustrated in FIG. 3D can be formed.

The use of the conductive film 201 as a current collector can reduce the thickness of the electrode. In addition, to increase the adhesion between the current collector and the electrode active material 202, the conductive film 201 formed by a sputtering method, a CVD method, or an evaporation method is used as a buffer layer; thus, the lithium-ion secondary battery can have high reliability. For the conductive film 201, aluminum, titanium, copper, or nickel can be used.

In addition, a current collector 204 may be attached to the conductive film 201, if necessary, to form an electrode of a lithium-ion secondary battery illustrated in FIG. 3E. Although not illustrated, a resin film may be formed between the current collector 204 and the conductive film 201 to provide moderate adhesion, with which stress can be reduced while conductivity is maintained. When the conductive film 201 is used as a buffer layer, the lithium-ion secondary battery including the electrode can have improved reliability such as rate characteristics. Such an electrode can be used as a flexible electrode and thus can be used in a flexible secondary battery.

The electrode active material 202 can be used as a positive electrode active material or a negative electrode active material. For the positive electrode active material, for example, a material into and from which carrier ions such as lithium ions can be inserted and extracted can be used. For example, a lithium-containing material with an olivine crystal structure, a layered rock-salt crystal structure, and a spinel crystal structure can be used.

Typical examples of the lithium-containing material with an olivine crystal structure represented by a general formula, LiMPO₄ (M is Fe(II), Mn(II), Co(II), or Ni(II)), are LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Lithium iron phosphate (LiFePO₄) is particularly preferable because it properly has properties necessary for the electrode active material (positive electrode active material, in particular), such as safety, stability, high capacity density, high potential, and the existence of lithium ions that can be extracted in initial oxidation (charge).

Examples of the lithium-containing material with a layered rock-salt crystal structure include lithium cobalt oxide (LiCoO₂); LiNiO₂; LiMnO₂; Li₂MnO₃; an NiCo-based lithium-containing material (a general formula thereof is LiNiₓCo₁₋ₓO₂, where 0<x<1) such as LiNi_{0.8}Co_{0.2}O₂; an NiMn-based lithium-containing material (a general formula thereof is LiNiₓMn₁₋ₓO₂, where 0<x<1) such as LiNi_{0.5}Mn_{0.5}O₂; and an NiMnCo-based lithium-containing material (also referred to as NMC, and a general formula thereof is LiNiₓMn_{y}Co_{1-x-y}O₂, where x>0, y>0, and x+y<1) such as LiNi_{1/3}Mn_{1/3}Co_{1/3}O₂. Moreover, the examples further include Li(Ni_{0.8}Co_{0.15}Al_{0.05})O₂ and Li₂MnO₃—LiMO₂ (M is Co, Ni, or Mn).

LiCoO₂ is particularly preferable because it has high capacity, stability in the air higher than that of LiNiO₂, and thermal stability higher than that of LiNiO₂, for example.

Examples of the lithium-containing material with a spinel crystal structure include LiMn₂O₄, Li₁₊ₓMn₂₋ₓO₄, Li(MnAl)₂O₄, and LiMn_{1.5}Ni_{0.5}O₄.

It is preferable to add a small amount of lithium nickel oxide (LiNiO₂ or LiNi₁₋ₓMO₂ (M=Co, Al, for example)) to a lithium-containing material with a spinel crystal structure which contains manganese such as LiMn₂O₄ because advantages such as minimization of the elution of manganese and the decomposition of an electrolyte solution can be obtained.

Alternatively, a composite oxide represented by a general formula, Li₍₂₋ⱼ₎MSiO₄ (M is Fe(II), Mn(II), Co(II), or Ni(II), where 0≦j≦2), can be used as the positive electrode active material. Typical examples of the general formula, Li₍₂₋ⱼ₎MSiO₄, include Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a NASICON compound represented by a general formula, AₓM₂(XO₄)₃ (A is Li, Na, or Mg, M is Fe, Mn, Ti, V, Nb, or Al, and X is S, P, Mo, W, As, or Si), can be used as the positive electrode active material. Examples of the NASICON compound include Fe₂(MnO₄)₃, Fe₂(SO₄)₃, and Li₃Fe₂(PO₄)₃. Still further alternatively, compounds represented by a general formula, Li₂MPO₄F, Li₂MP₂O₇, and Li₅MO₄ (M is Fe or Mn), a perovskite fluoride such as NaF₃ and FeF₃, a metal chalcogenide (a sulfide, a selenide, and a telluride) such as TiS₂ and MoS₂, a lithium-containing material with an inverse spinel crystal structure such as LiMVO₄, a vanadium oxide (e.g., V₂O₅, V₆O₁₃, and LiV₃O₈), a manganese oxide, and organic sulfur can be used as the positive electrode active material, for example.

In the case where the carrier ions are alkali metal ions other than lithium ions or alkaline-earth metal ions, the following may be used as the electrode active material: a compound or a material which is obtained by substituting an alkali metal (e.g., sodium or potassium) or an alkaline-earth metal (e.g., calcium, strontium, barium, beryllium, or magnesium) for lithium in any of the above-described compounds or oxides. For example, the electrode active material may be a layered oxide containing sodium such as NaFeO₂ or Na_{2/3}[Fe_{1/2}Mn_{1/2}]O₂.

Further alternatively, any of the aforementioned materials may be combined to be used as the positive electrode active material. For example, the electrode active material may be a solid solution containing any of the aforementioned materials, e.g., a solid solution containing LiCo_{1/3}Mn_{1/3}Ni_{1/3}O₂ and Li₂MnO₃.

The average particle diameter of the primary particle of the electrode active material is preferably greater than or equal to 50 nm and less than or equal to 100 μm.

Examples of the conductive additive of the electrode include acetylene black (AB), graphite (black lead) particles, carbon nanotubes, graphene, and fullerene.

A network for electrical conduction can be formed in the electrode by the conductive additive. The conductive additive also allows maintaining of a path for electrical conduction between the electrode active materials. The addition of the conductive additive to the electrode active material layer increases the electrical conductivity of the electrode active material layer.

A typical example of the binder is polyvinylidene fluoride (PVDF), and other examples of the binder include polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, and nitrocellulose.

The content of the binder in the electrode active material layer is preferably greater than or equal to 1 wt % and less than or equal to 10 wt %, more preferably greater than or equal to 2 wt % and less than or equal to 8 wt %, and still more preferably greater than or equal to 3 wt % and less than or equal to 5 wt %. The content of the conductive additive in the electrode active material layer is preferably greater than or equal to 1 wt % and less than or equal to 10 wt %, more preferably greater than or equal to 1 wt % and less than or equal to 5 wt %.

In the case where the electrode active material layer is formed by a coating method, the electrode active material, the binder, and the conductive additive are mixed to form slurry, and the slurry is applied to the base and dried.

This embodiment can be freely combined with Embodiment 1. For example, to fabricate a thin lithium-ion secondary battery, the electrode obtained in Embodiment 1 can be used as a negative electrode, the electrode obtained in this embodiment can be used as a positive electrode, and a separator and an electrolyte solution can be used. In that case, a conductive film that can provide moderate adhesion between the current collector and the electrode active material, with which stress can be reduced while conductivity is maintained, is provided, whereby reliability can be improved. Furthermore, a flexible lithium-ion secondary battery can be obtained.

This embodiment can be freely combined with any of the other embodiments.

### Embodiment 3

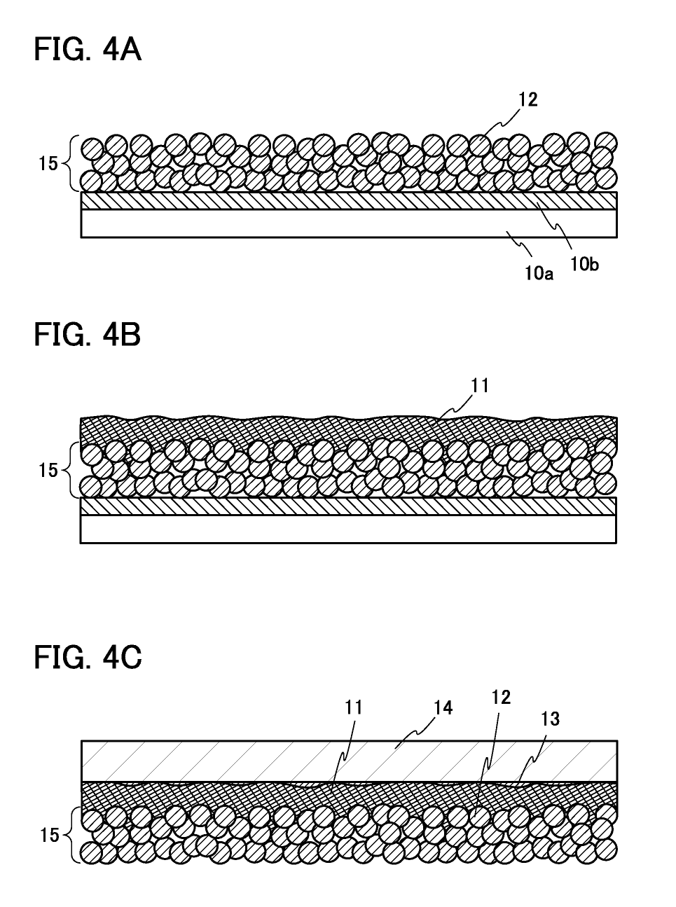

In this embodiment, an example of a method for forming an electrode of a lithium-ion secondary battery will be described below with reference to FIGS. 4A to 4C. In the method, a plastic film whose surface is provided with a film containing silicon oxide is used as a base.

First, an ethyl silicate solution is applied to a base 10a and dried, whereby a film 10b containing silicon oxide is formed on a surface of the base 10a. As the base 10a, polyethylene terephthalate (PET) is used.

Next, slurry containing an electrode active material 12 is applied and dried, so that an electrode active material layer 15 is formed (FIG. 4A). In addition to the electrode active material 12, a conductive additive, an N-methyl-2-pyrrolidone (NMP) solvent, polyvinylidene fluoride, and the like are mixed in the slurry. The slurry is applied to have a predetermined thickness with the use of a coating device such as a slot die coater.

Next, a conductive film 11 is formed by a sputtering method, a CVD method, or an evaporation method as illustrated in FIG. 4B. For the conductive film 11, aluminum, titanium, copper, or nickel is used.

Next, the film 10b containing silicon oxide and the electrode active material layer 15 are separated at the interface therebetween.

After that, a current collector 14 is attached and electrically connected to the conductive film 11. For the current collector 14, a metal foil such as an aluminum foil or a copper foil is used. Note that a resin film 13 of polyvinylidene fluoride, styrene-butadiene rubber, or the like may be formed on part of a surface of the current collector 14 in advance, in which case the resin film 13 serves as an adhesive and bonds the current collector 14 and the conductive film 11 to each other.

Through the above steps, the electrode of the lithium-ion secondary battery can be formed.

The conductive film 11 formed by a sputtering method, a CVD method, or an evaporation method can provide moderate adhesion between the current collector 14 and the electrode active material 12, with which stress can be reduced while conductivity is maintained. When the conductive film 11 is used as a buffer layer, the lithium-ion secondary battery including the electrode can have improved reliability.

The above process is an example and not particularly limited. Although the current collector 14 and the conductive film 11 are attached after the base 10a is separated in the above process, the base 10a may be separated after the conductive film is formed and the current collector 14 is attached thereto, for example.

This embodiment can be freely combined with any of the other embodiments.

### Embodiment 4

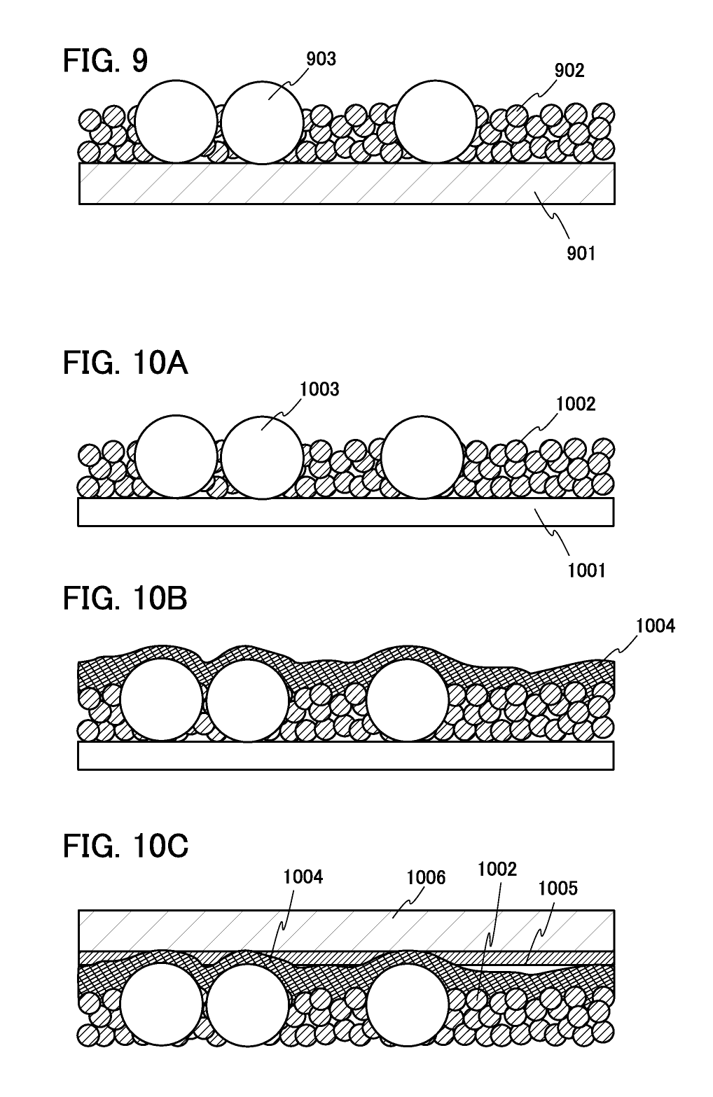

In this embodiment, an example of a method for forming an electrode including an electrode active material layer that contains insulating particles one of which is larger than one of electrode active material particles will be described with reference to FIG. 9.

First, slurry containing an electrode active material 902 and insulating particles 903 one of which is larger than one of the electrode active material particles is applied to a current collector 901 and dried, so that an electrode is formed. For the current collector 901, a material described in Embodiment 1 or 2, for example, copper or aluminum, can be used. FIG. 9 is a schematic cross-sectional view of the electrode. In the electrode, the slurry containing the electrode active material 902, a conductive additive (not illustrated), and the insulating particles 903 one of which is larger than one of the electrode active material particles are applied to the current collector 901 and dried. Since one of the insulating particles 903 is larger than one of the particles in the electrode active material 902, in a region containing the insulating particles, the insulating particles are not covered with a surface of an electrode active material layer. Thus, in the electrode active material layer, the thickness of the region containing the insulating particles 903 is larger than that of a region not containing the insulating particles.

When a secondary battery is formed using the electrode including the electrode active material 902 and the insulating particles 903, one of which is larger than one of the electrode active material particles, on the current collector 901, the thickness of a region containing the insulating particles in an electrode active material layer is larger than that of a region not containing the insulating particles. For this reason, the electrode active material layer can have room in the region not containing the insulating particles.

It is known that electrode active material particles expand and contract in charge and discharge. However, since the electrode active material layer has room in the region not containing the insulating particles, stress due to the expansion and contraction can be reduced or absorbed. In addition, stress due to the change in shape of the electrode can be reduced or absorbed. As a result, the separation of the electrode active material layer is less likely to occur; thus, a secondary battery including the electrode can have the long-term reliability or improved rate characteristics and can withstand the change in shape.

This embodiment can be freely combined with any of the other embodiments.

### Embodiment 5

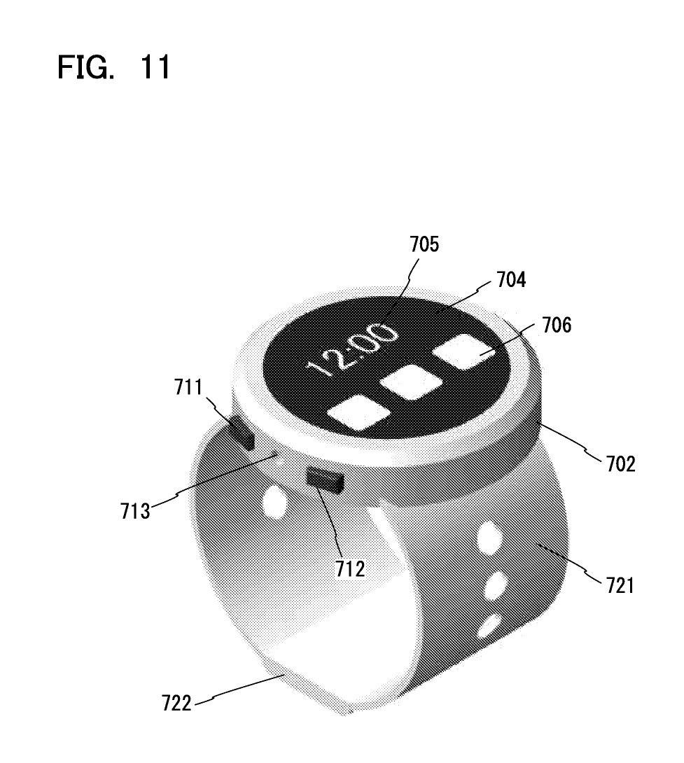

In this embodiment, an example of a method for forming an electrode including an electrode active material layer that contains insulating particles one of which is larger than one of electrode active material particles will be described with reference to FIGS. 10A to 10C.

First, slurry containing an electrode active material 1002 and insulating particles 1003 one of which is larger than one of electrode active material particles is applied to a base 1001 and dried. As the base 1001, a polyimide film tape can be used, for example. FIG. 10A is a schematic cross-sectional view of an electrode. In the electrode, the slurry containing the electrode active material 1002, a conductive additive (not illustrated), and the insulating particles 1003 one of which is larger than one of the electrode active material particles are applied to the base 1001 and dried. Since one of the insulating particles 1003 is larger than one of the particles in the electrode active material 1002, in a region containing the insulating particles, the insulating particles are not covered with a surface of an electrode active material layer. Thus, in the electrode active material layer, the thickness of the region containing the insulating particles 1003 is larger than that of a region not containing the insulating particles.

Next, a conductive film 1004 is formed by a sputtering method, a CVD method, or an evaporation method as illustrated in FIG. 10B. For the conductive film 1004, titanium, copper, or aluminum is used.

As illustrated in FIG. 10B, the conductive film 1004 fixes adjacent particles to each other in the electrode active material 1002. Furthermore, as illustrated in FIG. 10B, the conductive film 1004 fills at least part of a space between the particles in the electrode active material 1002. A surface of the conductive film 1004 is rough and not flat because the surface reflects the particles in the electrode active material 1002 and the insulating particles 1003.

Then, as illustrated in FIG. 10C, the base 1001 that is a polyimide film tape is separated from the electrode active materials 1002.

After that, a current collector 1006 is attached and electrically connected to the conductive film 1004. For the current collector 1006, a metal foil such as an aluminum foil or a copper foil is used. Note that a resin film 1005 of polyvinylidene fluoride, styrene-butadiene rubber, or the like may be formed on part of a surface of the current collector 1006 in advance, in which case the resin film 1005 serves as an adhesive and bonds the current collector 1006 and the conductive film 1004 to each other.

Through the above steps, the electrode of a lithium-ion secondary battery illustrated in FIG. 10C can be formed.

The conductive film 1004 formed by a sputtering method, a CVD method, or an evaporation method can provide moderate adhesion between the current collector 1006 and the electrode active material 1002, with which stress can be reduced while conductivity is maintained. When the conductive film 1004 is used as a buffer layer, the lithium-ion secondary battery including the electrode can have improved reliability.

Since the thickness of a region containing the insulating particles 1003 in an electrode active material layer is larger than that of a region not containing the insulating particles, the electrode active material layer can have room in the region not containing the insulating particles.

It is known that electrode active material particles expands and contracts in charge and discharge. However, since the electrode active material layer has room in the region not containing the insulating particles, stress due to the expansion and contraction can be reduced or absorbed. In addition, stress due to the change in shape of the electrode can be reduced or absorbed. As a result, the separation of the electrode active material layer is less likely to occur; thus, a secondary battery including the electrode can have the long-term reliability or improved rate characteristics and can withstand the change in shape.

This embodiment can be freely combined with any of the other embodiments.

### Embodiment 6

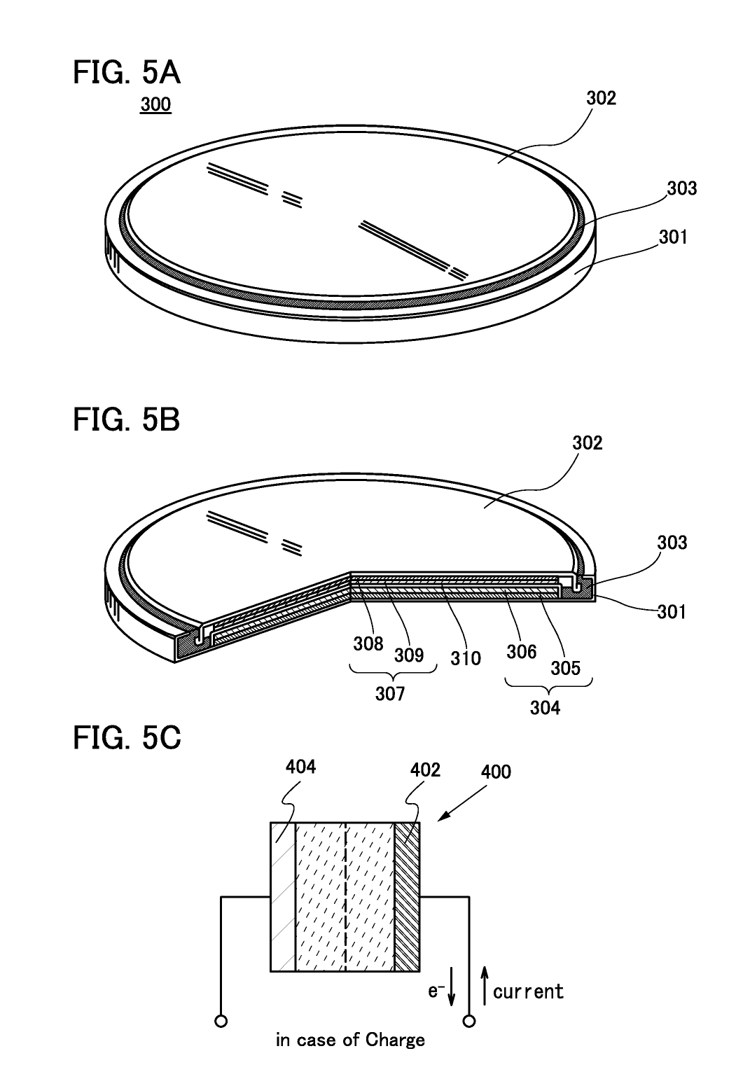

In this embodiment, examples of the structure of a secondary battery using electrodes formed by any of the formation methods described in Embodiments 1 to 5 are described with reference to FIGS. 5A to 5C, FIG. 6, and FIGS. 7A and 7B.

### (Coin-Type Secondary Battery)

FIG. 5A is an external view of a coin-type (single-layer flat type) secondary battery, and FIG. 5B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of, for example, polypropylene. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. A separator 310 and an electrolyte (not illustrated) are included between the positive electrode active material layer 306 and the negative electrode active material layer 309.

As the negative electrode 307, an electrode formed by the method for forming an electrode of one embodiment of the present invention described in Embodiment 1, which is one embodiment of the present invention, can be used. As the positive electrode 304, an electrode formed by the method for forming an electrode of one embodiment of the present invention described in Embodiment 2, which is one embodiment of the present invention, can be used.

As the separator 310, an insulator such as cellulose (paper), polyethylene with pores, and polypropylene with pores can be used.

For an electrolyte of the electrolyte solution, a material containing carrier ions is used. Typical examples of the electrolyte are lithium salts such as LiPF₆, LiClO₄, LiAsF₆, LiBF₄, LiCF₃SO₃, Li(CF₃SO₂)₂N, and Li(C₂F₅SO₂)₂N. These electrolytes may each be used alone or two or more of them may be used in an appropriate combination and in an appropriate ratio.

Note that when carrier ions are alkali metal ions other than lithium ions, or alkaline-earth metal ions, instead of lithium in the above lithium salts, an alkali metal (e.g., sodium and potassium) or an alkaline-earth metal (e.g., calcium, strontium, barium, beryllium, and magnesium) may be used for the electrolyte.

For a solvent of the electrolytic solution, a material with carrier ion mobility is used. As a solvent of an electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

When a gelled high-molecular material is used as the solvent of the electrolyte solution, safety against liquid leakage and the like is improved. Further, the secondary battery can be thinner and more lightweight. Typical examples of the gelled high-molecular material include a silicone gel, an acrylic gel, an acrylonitrile gel, polyethylene oxide, polypropylene oxide, and a fluorine-based polymer.

Alternatively, the use of one or more of ionic liquids (room temperature molten salts) which have features of non-flammability and non-volatility as the solvent of the electrolyte solution can prevent the secondary battery from exploding or catching fire even when the secondary battery internally shorts out or the internal temperature increases owing to, for example, overcharging.

In the case of using lithium ions as carriers, for example, one of lithium salts such as LiAlCl₄, LiSCN, LiBr, LiI, Li₂SO₄, Li₂B₁₀Cl₁₀, Li₂B₁₂Cl₁₂, LiC₄F₉SO₃, LiC(CF₃SO₂)₃, LiC(C₂F₅SO₂)₃, and LiN(C₄F₉SO₂)(CF₃SO₂) can be used as an electrolyte dissolved in the above solvent, or two or more of these lithium salts can be used in an appropriate combination in an appropriate ratio.

The electrolyte solution used for the secondary battery preferably contains a small amount of dust particles and elements other than the constituent elements of the electrolyte solution (hereinafter, also simply referred to as impurities) so as to be highly purified. Specifically, the weight ratio of impurities to the electrolyte solution is less than or equal to 1%, preferably less than or equal to 0.1%, and more preferably less than or equal to 0.01%. An additive agent such as vinylene carbonate may be added to the electrolyte solution.

For the positive electrode can 301 and the negative electrode can 302, a metal having corrosion resistance to an electrolyte solution, such as nickel, aluminum, and titanium, an alloy of such a metal, and an alloy of such a metal and another metal (e.g., stainless steel) can be used. Alternatively, the positive electrode can 301 and the negative electrode can 302 are preferably coated with, for example, nickel or aluminum in order to prevent corrosion caused by the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 5B, the positive electrode can 301, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type secondary battery 300 is fabricated.

Here, a current flow in charging a secondary battery is described with reference to FIG. 5C. When a secondary battery using lithium is regarded as a closed circuit, lithium ions move and a current flows in the same direction. Note that in the secondary battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the term “anode” or “cathode” is used, whether it is at the time of charging or discharging is noted and whether it corresponds to a positive electrode or a negative electrode is also noted.

Two terminals in FIG. 5C are connected to a charger, and a secondary battery 400 is charged. As the charge of the secondary battery 400 proceeds, a potential difference between electrodes increases. The positive direction in FIG. 5C is the direction in which a current flows from the one terminal outside the secondary battery 400 to a positive electrode 402, flows from the positive electrode 402 to a negative electrode 404 in the secondary battery 400, and flows from the negative electrode 404 to the other terminal outside the secondary battery 400. In other words, a current flows in the direction of a flow of a charging current.

### (Laminated Secondary Battery)

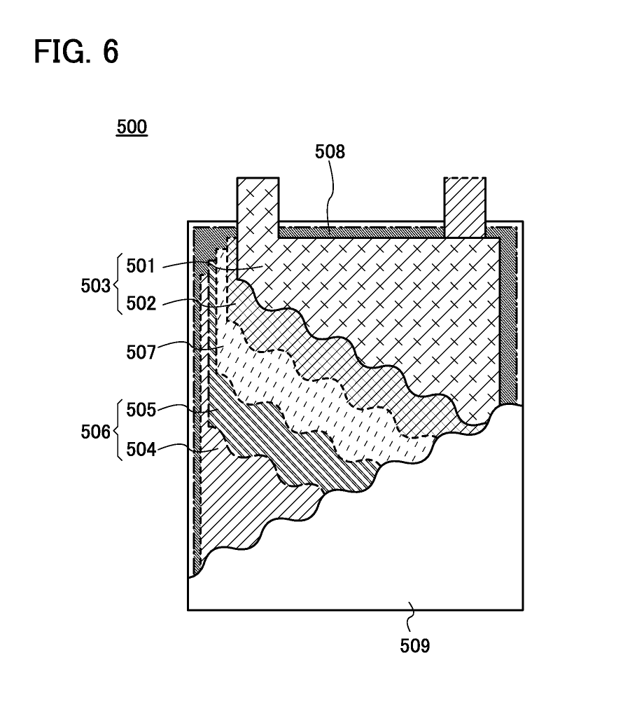

Next, an example of a laminated secondary battery is described with reference to FIG. 6.

A laminated secondary battery 500 illustrated in FIG. 6 includes a positive electrode 503 including a positive electrode current collector 501 and a positive electrode active material layer 502, a negative electrode 506 including a negative electrode current collector 504 and a negative electrode active material layer 505, a separator 507, an electrolyte solution 508, and an exterior body 509. The separator 507 is provided between the positive electrode 503 and the negative electrode 506 in the exterior body 509. The exterior body 509 is filled with the electrolyte solution 508.

In the laminated secondary battery 500 illustrated in FIG. 6, the positive electrode current collector 501 and the negative electrode current collector 504 also function as terminals for electrical contact with an external portion. For this reason, each of the positive electrode current collector 501 and the negative electrode current collector 504 is arranged so that part of the positive electrode current collector 501 and part of the negative electrode current collector 504 are exposed outside the exterior body 509.

As the exterior body 509 in the laminated secondary battery 500, a laminate film having a three-layer structure can be used, for example. In the three-layer structure, a highly flexible metal thin film of, for example, aluminum, stainless steel, copper, and nickel is provided over a film formed of a material such as polyethylene, polypropylene, polycarbonate, ionomer, and polyamide, and an insulating synthetic resin film of, for example, a polyamide-based resin and a polyester-based resin is provided as the outer surface of the exterior body over the metal thin film. With such a three-layer structure, permeation of an electrolyte solution and a gas can be blocked and an insulating property and resistance to the electrolyte solution can be provided.

### (Cylindrical Secondary Battery)

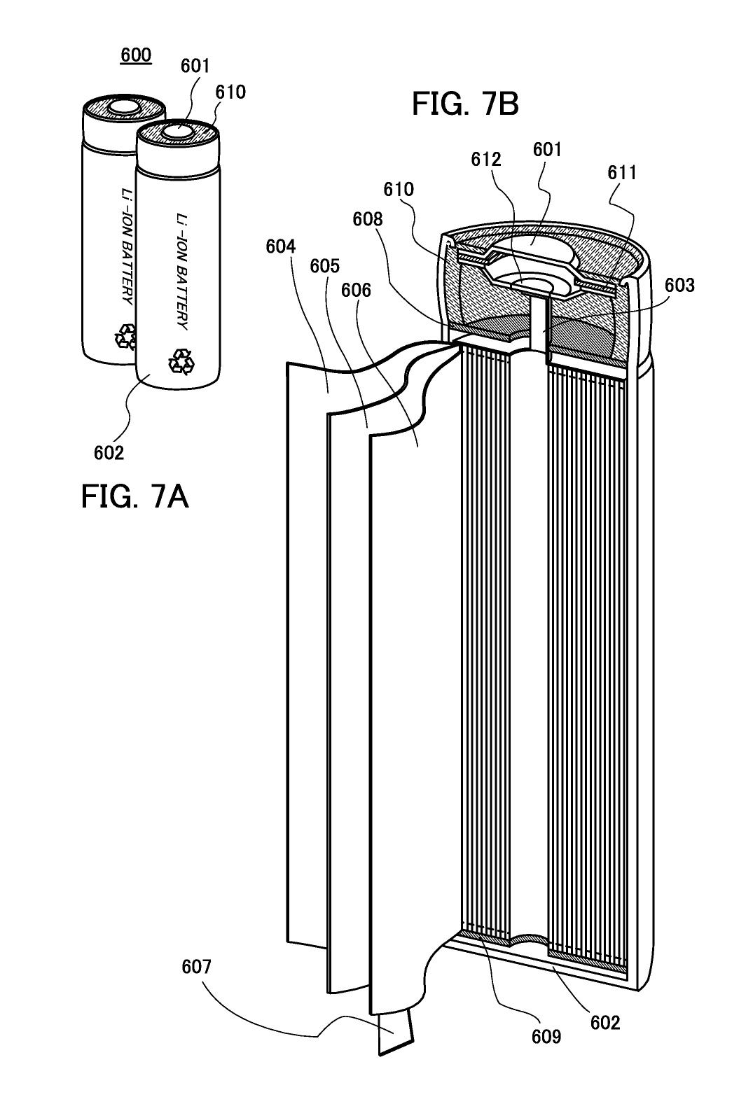

Next, an example of a cylindrical secondary battery is described with reference to FIGS. 7A and 7B. As illustrated in FIG. 7A, a cylindrical secondary battery 600 includes a positive electrode cap (battery cap) 601 on its top surface and a battery can (outer can) 602 on its side surface and bottom surface. The positive electrode cap 601 and the battery can 602 are insulated from each other with a gasket (insulating packing) 610.

FIG. 7B is a schematic cross-sectional view of the cylindrical secondary battery. Inside the battery can 602 having a hollow cylindrical shape, a battery element in which a strip-like positive electrode 604 and a strip-like negative electrode 606 are wound with a separator 605 positioned therebetween is provided. Although not illustrated, the battery element is wound around a center pin. One end of the battery can 602 is close and the other end thereof is open. For the battery can 602, a metal having corrosion resistance to a nonaqueous electrolyte solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion caused by the nonaqueous electrolyte solution. Inside the battery can 602, the battery element in which the positive electrode, the negative electrode, and the separator are wound is positioned between a pair of insulating plates 608 and 609 which face each other. Further, a nonaqueous electrolyte solution (not illustrated) is injected inside the battery can 602 provided with the battery element. As the nonaqueous electrolyte solution, a nonaqueous electrolyte solution that is similar to those of the above coin-type secondary battery and the laminated power storage device can be used.

The positive electrode 604 and the negative electrode 606 can be formed in a manner similar to that of the positive electrode and the negative electrode of the coin-type secondary battery described above; however, the difference lies in that, electrode active materials are formed on both sides of a current collector in each electrode because the positive electrode and the negative electrode of the cylindrical secondary battery are wound. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611 is a heat sensitive resistor whose resistance increases as temperature rises, and controls the amount of current by increase in resistance to prevent abnormal heat generation. Note that barium titanate (BaTiO₃)-based semiconductor ceramic or the like can be used for the PTC element.

Note that in this embodiment, the coin-type secondary battery, the laminated secondary battery, and the cylindrical secondary battery are given as examples of the secondary battery; however, any of secondary batteries with a variety of shapes, such as a sealed secondary battery and a rectangular secondary battery, can be used. Further, a structure in which a plurality of positive electrodes, a plurality of negative electrodes, and a plurality of separators are stacked or rolled may be employed.

As the positive electrodes and the negative electrodes of the secondary battery 300, the secondary battery 500, and the secondary battery 600, which are described in this embodiment, electrodes formed by the method for forming an electrode for a secondary battery which is one embodiment of the present invention are used. Thus, the discharge capacity of the secondary batteries 300, 500, and 600 can be increased.

Note that this embodiment can be freely combined with any of the other embodiments.

### Embodiment 7

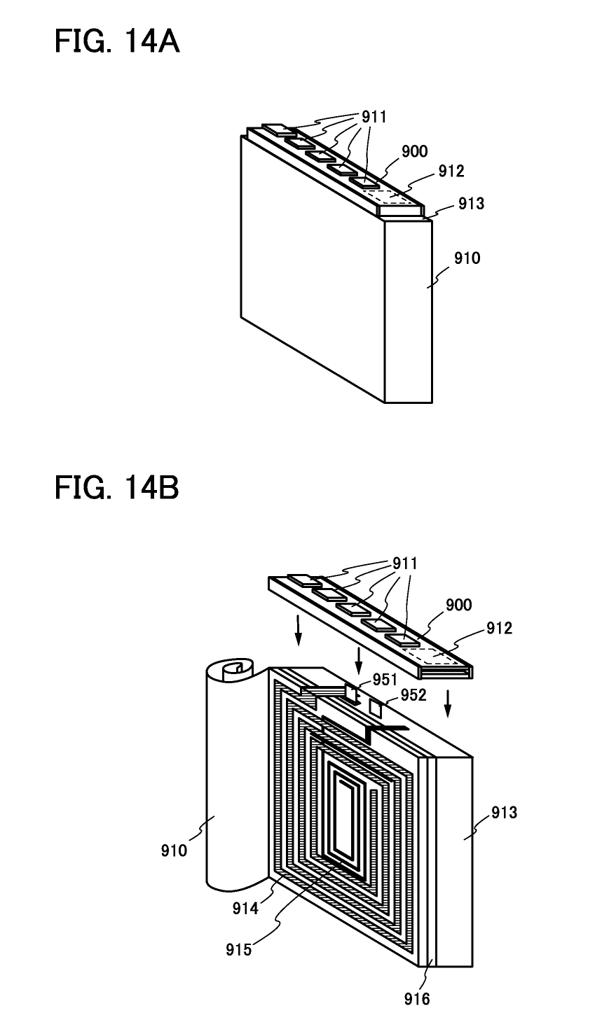

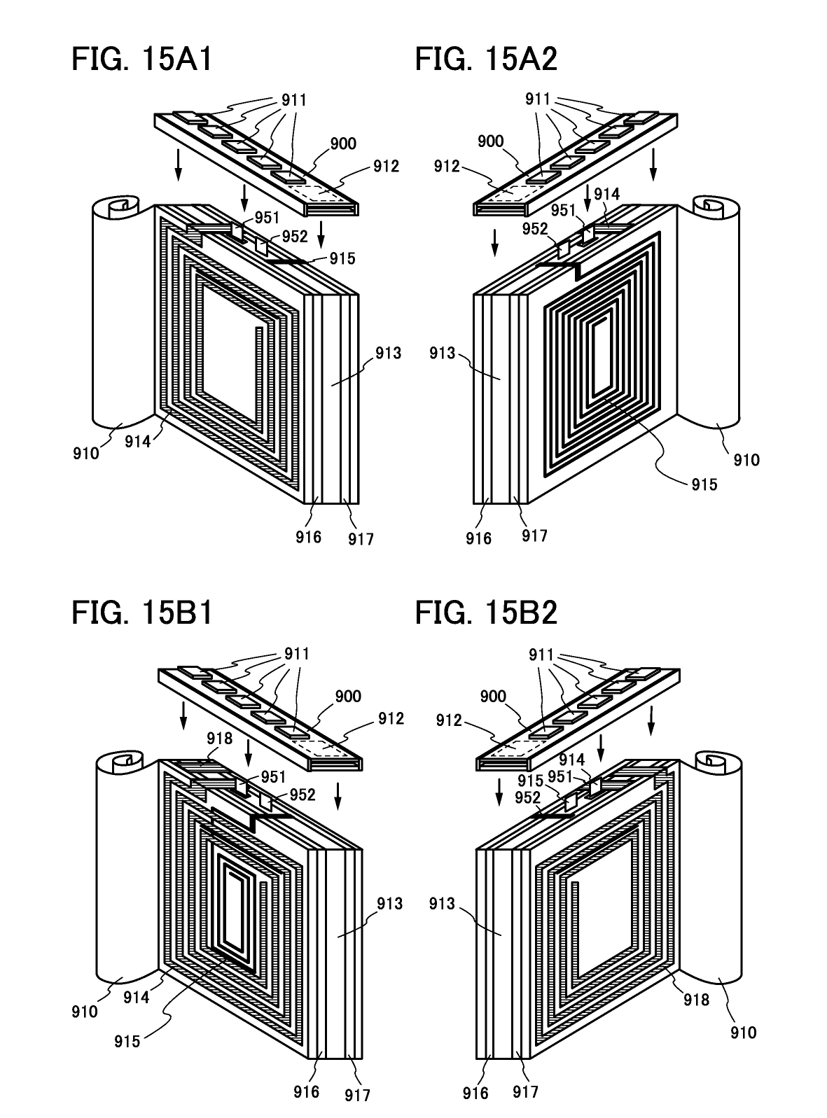

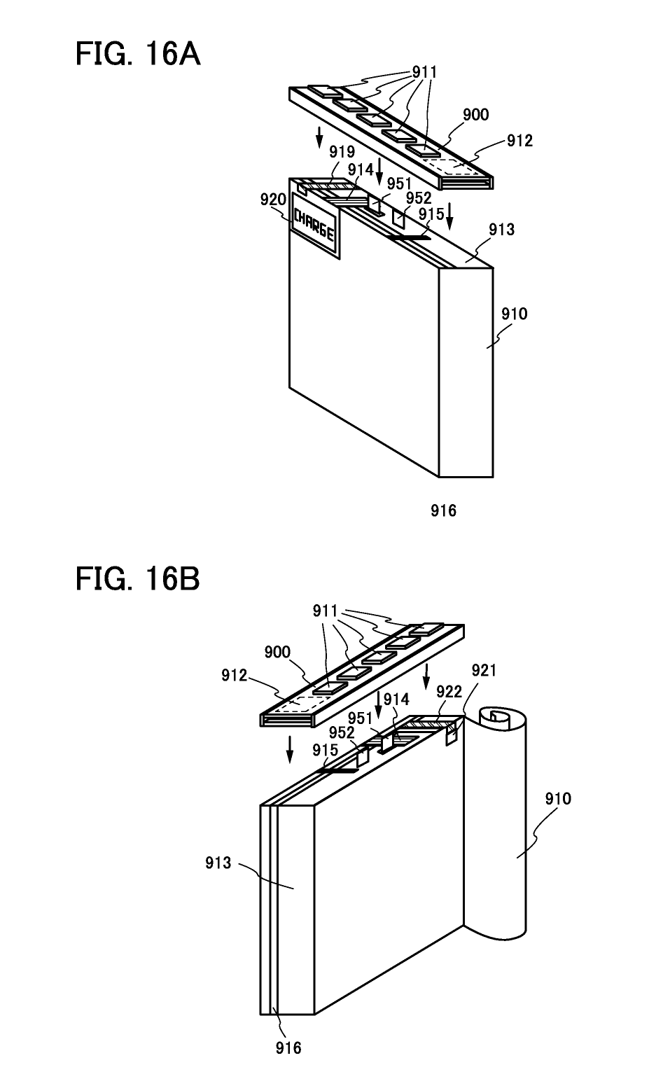

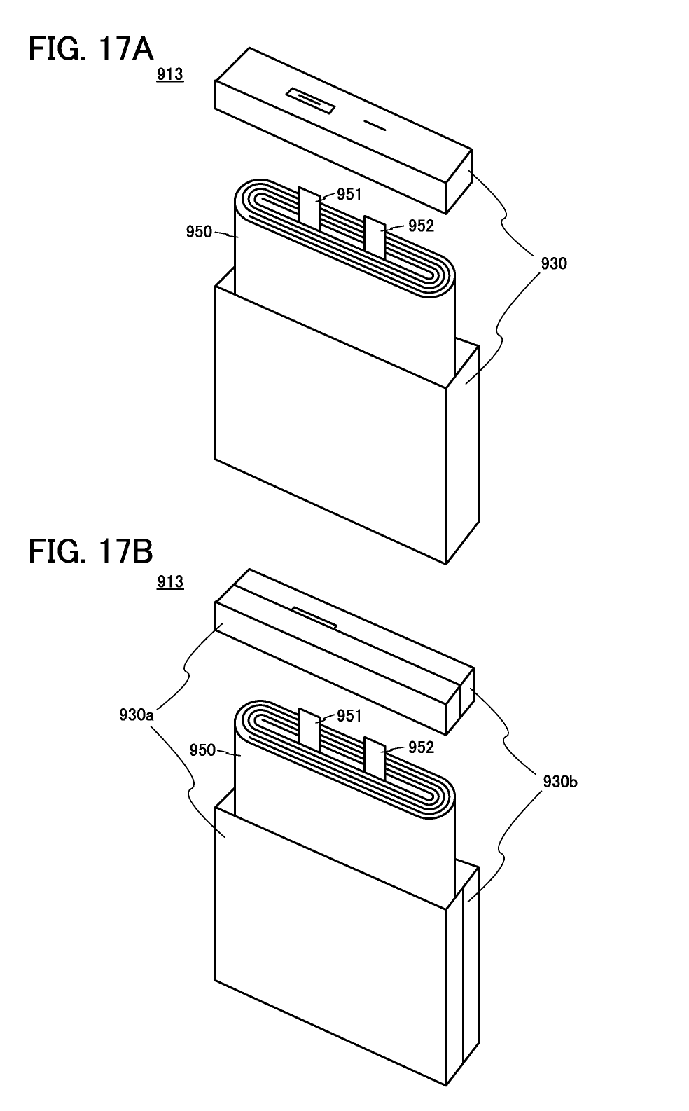

In this embodiment, structural examples of a power storage device will be described with reference to FIGS. 14A and 14B, FIGS. 15A1, 15A2, 15B1, and 15B2, FIGS. 16A and 16B, FIGS. 17A and 17B, and FIG. 18.

FIGS. 14A and 14B show external views of a power storage device. The power storage device includes a circuit board 900 and a power storage unit 913. A label 910 is attached to the power storage unit 913. As illustrated in FIG. 14B, the power storage system further includes a terminal 951, a terminal 952, and an antenna 914 and an antenna 915 which are provided behind the label 910.

The circuit board 900 includes terminals 911 and a circuit 912. The terminals 911 are connected to the terminals 951 and 952, the antennas 914 and 915, and the circuit 912. Note that a plurality of terminals 911 serving as a control signal input terminal, a power supply terminal, and the like may be provided.

The circuit 912 may be provided on the rear surface of the circuit board 900. Note that the shape of the antennas 914 and 915 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 914 or the antenna 915 may be a flat-plate conductor. The flat-plate conductor can serve as one of conductors for electric field coupling. That is, the antenna 914 or the antenna 915 may serve as one of two conductors of a capacitor. Thus, electric power can be transmitted and received not only by an electromagnetic field or a magnetic field but also by an electric field.

The line width of the antenna 914 is preferably larger than that of the antenna 915. This makes it possible to increase the amount of electric power received by the antenna 914.

The power storage device includes a layer 916 between the power storage unit 913 and the antennas 914 and 915. The layer 916 has a function of blocking an electromagnetic field from the power storage unit 913, for example. As the layer 916, for example, a magnetic body can be used.

Note that the structure of the power storage device is not limited to that in FIGS. 14A and 14B.

For example, as illustrated in FIGS. 15A1 and 15A2, two opposite sides of the power storage unit 913 in FIGS. 14A and 14B may be provided with the respective antennas. FIG. 15A1 is an external view showing one of the opposite sides, and FIG. 15A2 is an external view showing the other of the opposite sides. Note that for the same portions as the power storage device in FIGS. 14A and 14B, description on the power storage device in FIGS. 14A and 14B can be referred to as appropriate.

As illustrated in FIG. 15A1, the antenna 914 is provided on one of the opposite sides of the power storage unit 913 with the layer 916 provided therebetween, and as illustrated in FIG. 15A2, the antenna 915 is provided on the other of the opposite sides of the power storage unit 913 with a layer 917 provided therebetween. The layer 917 has a function of blocking an electromagnetic field from the power storage unit 913, for example. As the layer 917, for example, a magnetic body can be used.

With the above structure, both the antenna 914 and the antenna 915 can be increased in size.

Alternatively, as illustrated in FIGS. 15B1 and 15B2, two opposite sides of the power storage unit 913 in FIGS. 14A and 14B may be provided with different types of antennas. FIG. 15B1 is an external view showing one of the opposite sides, and FIG. 15B2 is an external view showing the other of the opposite sides. Note that for the same portions as the power storage device in FIGS. 14A and 14B, description on the power storage device in FIGS. 14A and 14B can be referred to as appropriate.

As illustrated in FIG. 15B1, the antennas 914 and 915 are provided on one of the opposite sides of the power storage unit 913 with the layer 916 provided therebetween, and as illustrated in FIG. 15B2, an antenna 918 is provided on the other of the opposite sides of the power storage unit 913 with the layer 917 provided therebetween. The antenna 918 has a function of performing data communication with an external device, for example. An antenna with a shape that can be applied to the antennas 914 and 915 can be used as the antenna 918, for example. As an example of a method for communication between the power storage device and another device via the antenna 918, a response method such as NFC can be given.

Alternatively, as illustrated in FIG. 16A, the power storage unit 913 in FIGS. 14A and 14B may be provided with a display device 920. The display device 920 is electrically connected to the terminal 911 via a terminal 919. It is possible that the label 910 is not provided in a portion where the display device 920 is provided. Note that for the same portions as the power storage system in FIGS. 14A and 14B, description on the power storage device in FIGS. 14A and 14B can be referred to as appropriate.

The display device 920 can display, for example, an image showing whether charging is being carried out or an image showing the amount of stored power. As the display device 920, electronic paper, a liquid crystal display device, an electroluminescent (EL) display device, or the like can be used. For example, the power consumption of the display device 920 can be reduced when electronic paper is used.

Alternatively, as illustrated in FIG. 16B, the power storage unit 913 in FIGS. 14A and 14B may be provided with a sensor 921. The sensor 921 is electrically connected to the terminal 911 via a terminal 922. Note that the sensor 921 may be provided behind the label 910. Note that for the same portions as the power storage device in FIGS. 14A and 14B, description on the power storage device in FIGS. 14A and 14B can be referred to as appropriate.

With the sensor 921, for example, data on an environment (e.g., temperature) where the power storage device is placed can be determined and stored in a memory inside the circuit 912.

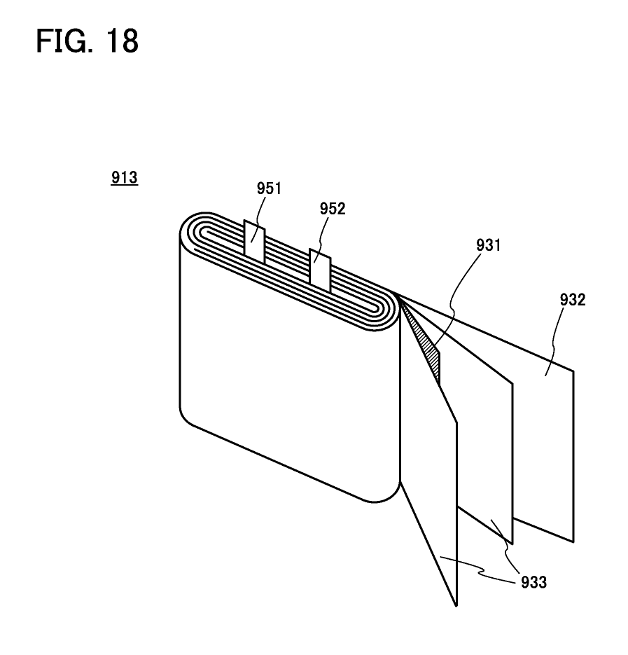

Furthermore, structural examples of the power storage unit 913 are described with reference to FIGS. 17A and 17B and FIG. 18.

In the power storage unit 913 illustrated in FIG. 17A, a wound body 950 having the terminals 951 and 952 is provided in a housing 930. The wound body 950 is soaked in an electrolyte solution inside the housing 930. The terminal 952 is in contact with the housing 930. An insulator or the like prevents contact between the terminal 951 and the housing 930. Note that FIG. 17A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 17B, the housing 930 in FIG. 17A may be formed using a plurality of materials. For example, in the power storage unit 913 in FIG. 17B, a housing 930a and a housing 930b are attached to each other and the wound body 950 is provided in a region surrounded by the housing 930a and the housing 930b.

For the housing 930a, an insulating material such as an organic resin can be used. In particular, when a material such as an organic resin is used for the side on which an antenna is formed, an electric field can be prevented from being blocked by the power storage unit 913. When an electric field is not significantly blocked by the housing 930a, an antenna such as the antenna 914 or the antenna 915 may be provided inside the housing 930. For the housing 930b, a metal material can be used, for example.

FIG. 18 shows a structure of the wound body 950. The wound body 950 includes a negative electrode 931, a positive electrode 932, and a separator 933. The wound body 950 is obtained by winding a sheet of a stack in which the negative electrode 931 overlaps with the positive electrode 932 with the separator 933 provided therebetween. Note that a plurality of sheets each including the negative electrode 931, the positive electrode 932, and the separator 933 may be stacked.

The negative electrode 931 is connected to the terminal 911 in FIGS. 14A and 14B via one of the terminals 951 and 952. The positive electrode 932 is connected to the terminal 911 in FIGS. 14A and 14B via the other of the terminals 951 and 952.

This embodiment can be implemented in combination with any of the other embodiments as appropriate.

### Embodiment 8

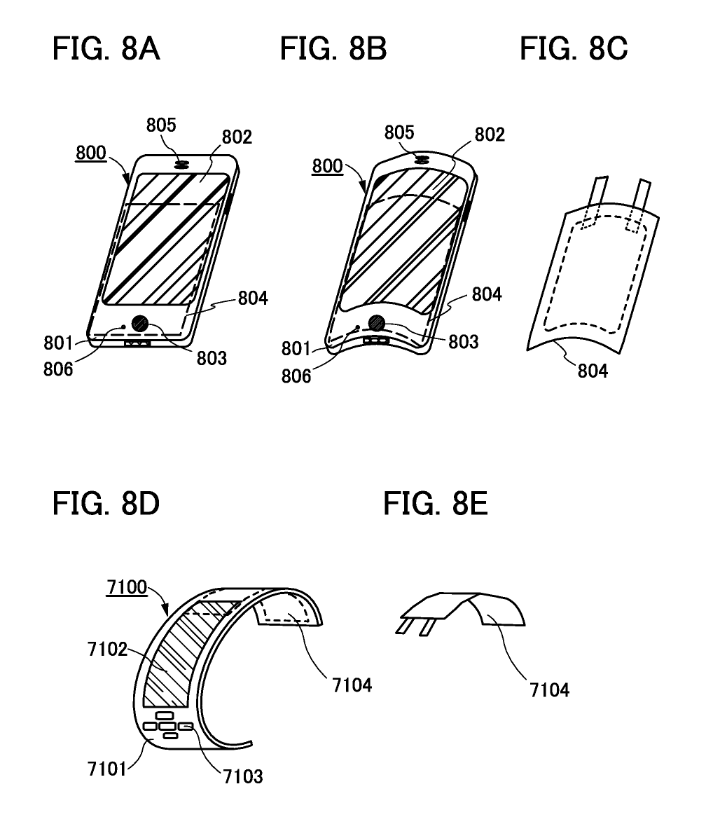

In this embodiment, examples of electronic devices including any of the secondary batteries illustrated in the above embodiments are described with reference to FIGS. 8A to 8E and FIG. 11.

Examples of electronic devices including secondary batteries are cameras such as digital cameras and digital video cameras, digital photo frames, mobile phones (also referred to as cellular phones or portable telephone devices), portable game consoles, portable information terminals, and audio reproducing devices. FIGS. 8A to 8E and FIG. 11 illustrate specific examples of these electronic devices.

FIG. 8A illustrates an example of a mobile phone. A mobile phone 800 is provided with a display portion 802 incorporated in a housing 801, an operation button 803, a speaker 805, a microphone 806, and the like. The use of a secondary battery 804 of one embodiment of the present invention in the mobile phone 800 results in weight reduction.

When the display portion 802 of the mobile phone 800 illustrated in FIG. 8A is touched with a finger or the like, data can be input into the mobile phone 800. Users can make a call or text messaging by touching the display portion 802 with their fingers or the like.

There are mainly three screen modes for the display portion 802. The first mode is a display mode mainly for displaying an image. The second mode is an input mode mainly for inputting data such as characters. The third mode is a display-and-input mode in which two modes of the display mode and the input mode are combined.

For example, in the case of making a call or composing an e-mail, a text input mode mainly for inputting text is selected for the display portion 802 so that text displayed on a screen can be inputted.

When a sensing device including a sensor such as a gyroscope and an acceleration sensor for detecting inclination is provided in the mobile phone 800, display on the screen of the display portion 802 can be automatically changed in direction by determining the orientation of the mobile phone 800 (whether the mobile phone 800 is placed horizontally or vertically for a landscape mode or a portrait mode).

The screen modes are switched by touching the display portion 802 or operating the operation button 803 of the housing 801. Alternatively, the screen modes may be switched depending on the kind of the image displayed on the display portion 802. For example, when a signal of an image displayed on the display portion is a signal of moving image data, the screen mode is switched to the display mode. When the signal is a signal of text data, the screen mode is switched to the input mode.

Moreover, in the input mode, if a signal detected by an optical sensor in the display portion 802 is detected and the input by touch on the display portion 802 is not performed for a certain period, the screen mode may be controlled so as to be changed from the input mode to the display mode.

The display portion 802 can function as an image sensor. For example, an image of a palm print, a fingerprint, or the like is taken with the display portion 802 touched with the palm or the finger, whereby personal authentication can be performed. Furthermore, by providing a backlight or a sensing light source that emits near-infrared light in the display portion, an image of a finger vein, a palm vein, and the like can be taken.

FIG. 8B illustrates the mobile phone 800 that is bent. When the whole mobile phone 800 is bent by the external force, the secondary battery 804 included in the mobile phone 800 is also bent. FIG. 8C illustrates the bent secondary battery 804. The secondary battery 804 is a laminated secondary battery.

FIG. 11 illustrates a smart watch. The smart watch can include a housing 702, a display panel 704, operation buttons 711 and 712, a connection terminal 713, a band 721, a clasp 722, and so on. The use of the secondary battery of one embodiment of the present invention in the smart watch results in weight reduction.

The display panel 704 mounted in the housing 702 serving as a bezel includes a non-rectangular display region. The display panel 704 can display an icon 705 indicating time and another icon 706.

The smart watch in FIG. 11 can have a variety of functions, for example, a function of displaying a variety of data (e.g., a still image, a moving image, and a text image) on a display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading program or data stored in a recording medium and displaying the program or data on a display portion.

The housing 702 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and so on.

FIG. 8D illustrates an example of a bangle display device. A portable display device 7100 includes a housing 7101, a display portion 7102, an operation button 7103, and a secondary battery 7104. FIG. 8E illustrates the bent secondary battery 7104.

Note that the structure and the like described in this embodiment can be used as appropriate in combination with any of the structures and the like in the other embodiments.

### Example

In this example, a coin-type secondary battery including the electrode of one embodiment of the present invention was fabricated on the basis of Embodiment 1. The charge and discharge characteristics of the fabricated coin-type secondary battery will be shown in this example.

<Structure of Coin Cell>

Here, the structure of the fabricated coin-type secondary battery will be described.

### [Formation of Positive Electrode]

First, positive electrode slurry containing graphene was formed as a conductive additive. Lithium iron phosphate (LiFePO₄) was used as a positive electrode active material, and polyvinylidene fluoride (PVdF) was used as a binder. Lithium iron phosphate, graphene oxide, and polyvinylidene fluoride were mixed in a ratio of 94.2:0.8:5. Then, N-methyl-2-pyrrolidone (NMP) was added as a dispersion medium for viscosity adjustment, and mixing was performed. Thus, the positive electrode slurry was formed.

The positive electrode slurry formed by the above method was applied to a positive electrode current collector (20-μm-thick aluminum).

Subsequently, the slurry provided on the current collector was dried with a circulation dryer. The drying was performed in an air atmosphere at 80° C. for 40 minutes.

Subsequently, graphene oxide was reduced by reaction in a solvent containing a reducer. The reduction treatment was performed at 60° C. for 4.5 hours. Ascorbic acid was used as the reducer. As the solvent, ethanol was used. The concentration of the reducer was 13.5 g/L.

After that, cleaning with ethanol was performed, and drying was performed at 70° C. for 10 hours. The drying was performed in a vacuum atmosphere.

Subsequently, the positive electrode active material layer was pressed by a roll press method so as to be consolidated.

The positive electrode active material layer was formed by the above method. The positive electrode active material layer was punched, and the following coin-type secondary batteries were formed. The content of LiFePO₄ in a positive electrode which was combined with a negative electrode A described later into a coin-type secondary battery was 6.3 mg/cm², and the content of LiFePO₄ in a positive electrode which was combined with a negative electrode B described later into a coin-type secondary battery was 6.6 mg/cm².

### [Formation of Negative Electrode]

### (Formation of Negative Electrode A)

First, a glass substrate over which a polyethylene base was fixed with Kapton tape was prepared (substrate A).

Next, with the use of a negative electrode active material, a binder, and a dispersion medium, negative electrode slurry was formed. In this example, artificial graphite (MCMB) with a particle diameter of 10 μm and polyvinylidene fluoride (PVdF) were used as the negative electrode active material and as the binder, respectively. The ratio in the slurry was set to graphite:PVdF=90:10 (weight ratio). To form the negative electrode slurry, graphite and an NMP solution of PVdF were mixed with a mixer, and then, NMP was added for viscosity adjustment and mixing with a mixer was performed again.

The negative electrode slurry formed by the above method was applied to the substrate A with the use of a blade. In other words, the negative electrode slurry was applied to the polyethylene base. In the application step, the distance between the blade and the base were 220 μm.

Subsequently, drying was performed with an oven in an air atmosphere at 70° C. for 30 minutes. After that, drying was performed in a reduced pressure environment at 170° C. for 10 hours. In this manner, the electrode active material layer was formed.

Over a surface of the substrate A over which the electrode active material layer was formed, a 3-μm-thick titanium (Ti) film was formed by a sputtering method. Specifically, a direct current (DC) sputtering method was used under the following conditions: the distance between a target and the substrate (T-S distance) was 110 mm, the substrate temperature was room temperature, the pressure was 0.4 Pa, the DC power was 6 kW, and the atmosphere was an argon atmosphere (the proportion of the argon flow was 100%).

The Kapton tape was peeled off from the substrate A over which the Ti film was formed and the glass substrate was separated, so that an electrode having a structure of “base\graphite active material layer\Ti film” was obtained. This electrode was punched into a round shape with a diameter of 12 mm using an electrode punching machine. The base was peeled off from this electrode with the use of low adhesion between the base and the graphite active material layer, so that a structural body with a structure of “graphite active material layer\Ti film” with a diameter of 12 mm was obtained. Then, this structure was placed on a copper current collector (18-μm-thick rolled copper foil) with a diameter of 16 mm, whereby an electrode having a structure of “copper current collector\Ti film\graphite active material layer” was obtained. This electrode was used as the negative electrode A. The active material content in the fabricated negative electrode A was 3.5 mg/cm².

The active material content in the negative electrode A was calculated as follows. First, another structural body with a structure of “graphite active material layer\Ti film” was obtained by punching the rest of the electrode. After the structural body was weighed, a coin cell including the structural body and a Li foil as electrodes was fabricated. An electrolyte solution and a member similar to those in a sample A, which is described later, were used. This coin cell was subjected to a charge and discharge measurement at a sufficiently low current value. From the capacity at the time of Li release and the capacity of the artificial graphite used in this experiment, i.e., 330 mAh/g, the weight of the graphite active material at the time of measurement was calculated to be 83% of the weight of the structural body with a structure of “graphite active material layer \ Ti film.” The active material content in the negative electrode A was calculated by multiplying the measured weight by the percentage (83%).

### (Formation of Negative Electrode B as Comparative Example)

The negative electrode B, which was a comparative example of the negative electrode A, was fabricated. The negative electrode B is a general electrode in which a copper foil is used as a current collector. First, with the use of a negative electrode active material, a binder, and a dispersion medium, negative electrode slurry was formed.

In this example, artificial graphite (MCMB) with a particle diameter of 10 μm and polyvinylidene fluoride (PVdF) were used as the negative electrode active material and as the binder, respectively. The ratio in the slurry was set to graphite:PVdF=90:10 (weight ratio). To form the negative electrode slurry, graphite and an NMP solution of PVdF were mixed with a mixer, and then, NMP was added for viscosity adjustment and mixing with a mixer was performed again.

The negative electrode slurry formed by the above method was applied to a current collector (18-μm-thick rolled copper foil) with the use of a blade. The distance between the blade and the current collector was set to 220 μm.

Subsequently, drying was performed with an oven in an air atmosphere at 70° C. for 30 minutes. After that, drying was performed in a reduced pressure environment at 170° C. for 10 hours. In this manner, the negative electrode B was formed. The active material content in the obtained negative electrode B was 4.3 mg/cm².

### [Electrolyte Solution]

The electrolyte solution used was obtained as follows: 1 mol of LiPF₆ was dissolved as a lithium salt in 1 L of solvent in which ethylene carbonate (EC) and diethyl carbonate (DEC) were mixed at a volume ratio of 3:7.

### [Separator]

As a separator, a polypropylene (PP) separator was used.

### [Formation of Coin Cell]

A positive electrode can and a negative electrode can were formed of stainless steel (SUS). A gasket, a spacer, and a washer were used. The positive electrode can, the positive electrode, and the separator were stacked, an electrolyte solution was dropped, the negative electrode (the negative electrode A or the negative electrode B), the gasket, and the negative electrode can were stacked thereover, and the positive electrode can and the negative electrode can were crimped to each other with a coin cell crimper. Thus, the coin-type secondary battery was fabricated. The coin-type secondary battery fabricated using the negative electrode A is referred to as the sample A, and the coin-type secondary battery fabricated using the negative electrode B, which is a comparative example of the negative electrode A, is referred to as a comparative sample B.

When the value obtained by dividing the capacity of the positive electrode by the capacity of the negative electrode is a capacity ratio, the capacity ratio of the sample A was 68.6% and the capacity ratio of the comparative sample B was 79.5%. The higher the capacity ratio is, the more lithium is likely to be deposited at the negative electrode. Lithium deposition might cause reductions in capacity and safety of a battery.

### [Aging]

Before a cycle test, the sample A and the comparative sample B were subjected to aging in the following manner. First, the samples were charged to 3.2 V at 0.02 C. Then, the coin cells were broken down once to be degassed. Next, the coin cells were rebuilt with the use of new members for coin cells. At this time, an electrolyte solution was added. After that, charging and discharging to from 2.0 V to 4.0 V at a charge rate of 0.2 C and a discharge rate of 0.2 C were repeated twice. Note that CCCV charging was employed and CV was finished at the condition in which the current value reached to that at 0.01 C.

### [Cycle Test]

After the aging, the sample A and the comparative sample B were subjected to the cycle tests at a high charge rate. The voltage ranged from 2.0 V to 4.0 V, a charge rate was 3 C, and a discharge rate was 0.2 C. Note that CCCV charging was employed and CV was finished at the condition in which the current value reached to that at 0.01 C.

### [Test Results]

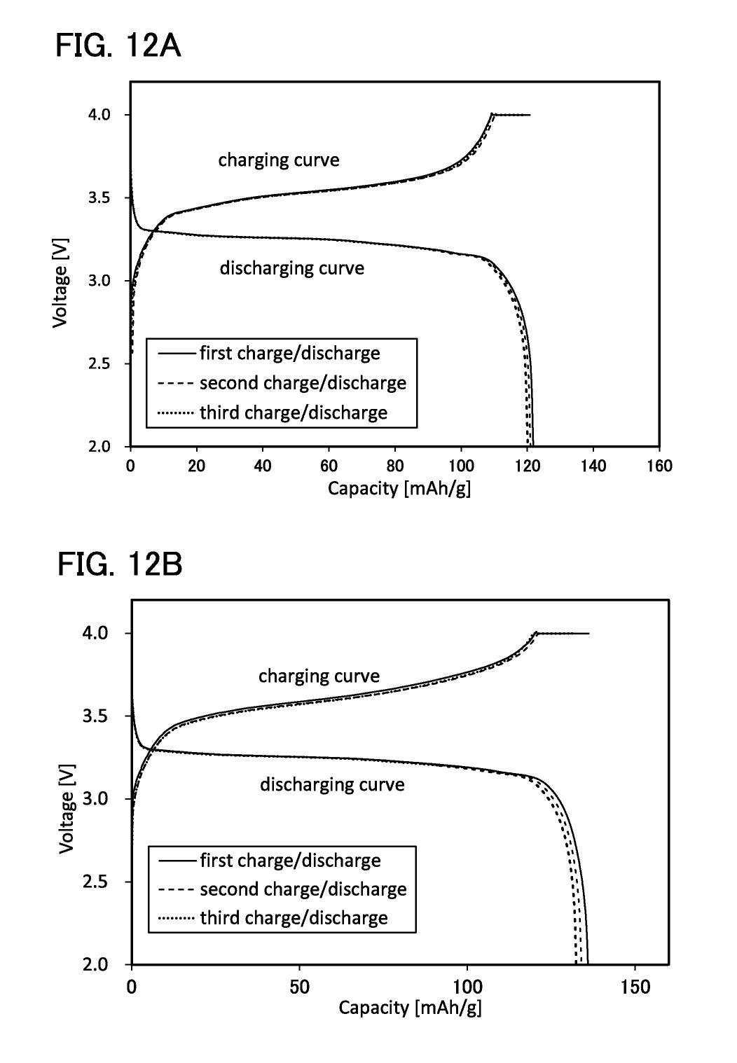

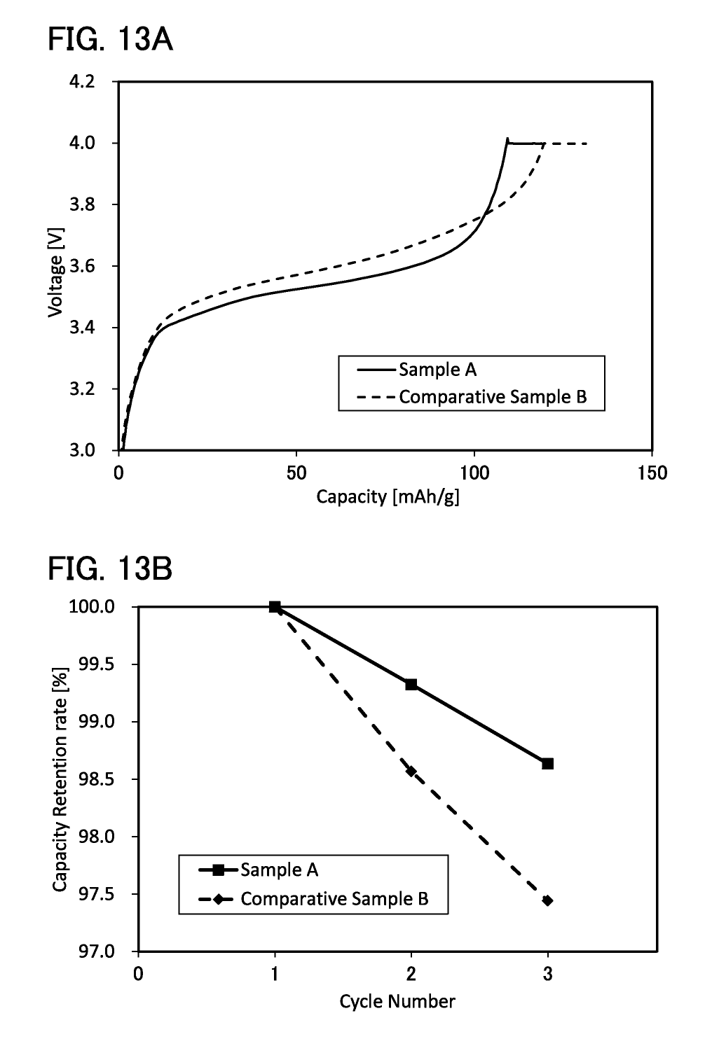

FIGS. 12A and 12B and FIG. 13A show results of the cycle tests. FIG. 12A shows results of charge and discharge capacity of the sample A including a graphite electrode in which a Ti film was formed by a sputtering method. FIG. 12B shows results of the charge and discharge capacity of the comparative sample B. In each of FIGS. 12A and 12B, the lateral axis represents capacity per gram of a positive electrode active material layer and the longitudinal axis represents voltage. FIG. 13A shows a charge curve of the sample A in the third cycle and a charge curve of the comparative sample B in the third cycle.

FIG. 13A shows that overpotential is smaller in the sample A than in the comparative sample B in charging. Since the sample A and the comparative sample B were formed using the same positive electrodes, the difference in overpotential is due to the difference between the graphite negative electrodes. The risk of lithium deposition is low when overpotential in charging is small. Thus, the results in FIG. 13A indicates that the sample A is suitable for rapid charging.

The coin cells were broken down after the cycle tests to observe with a SEM whether metal lithium is deposited on surfaces of the negative electrodes.

By the SEM observation, metal lithium was observed on the surface of the negative electrode in the comparative sample B, and not on the surface of the negative electrode in the sample A. This result also indicates that the sample A is suitable for rapid charging.

FIG. 13B is a graph comparing the capacity retention rates of the sample A and the comparative sample B in the cycle tests. FIG. 13B shows that the capacity retention rate of the sample A was higher than that of the comparative sample B in the cycle tests. In the comparative sample B, metal lithium was deposited in rapid charging, which might be a cause of the lower capacity retention rate.

The above results show that the sample A including a graphite electrode in which a Ti film was formed by a sputtering method has favorable rate characteristics and is suitable for rapid charging.

This application is based on Japanese Patent Application serial no. 2013-218885 filed with Japan Patent Office on Oct. 22, 2013, the entire contents of which are hereby incorporated by reference.

What is claimed is:

1. An electrode comprising:
a conductive film; and
an active material layer over and in contact with the conductive film, the active material layer comprising a plurality of active material particles,
wherein a surface of the active material layer is rougher than the opposite surface of the active material layer.

2. The electrode according to claim 1, wherein the conductive film fills a depression on the surface of the active material layer.

3. The electrode according to claim 1, wherein the conductive film is thinner than the active material layer.

4. The electrode according to claim 1, wherein the active material layer comprises graphite.

5. The electrode according to claim 1, wherein the electrode is flexible.

6. The electrode according to claim 1,
wherein the active material layer further comprises an insulating particle,
wherein the active material layer comprises a first region and a second region,
wherein the first region comprises the insulating particle, and
wherein the first region is thicker than the second region.

7. A power storage device comprising the electrode according to claim 1.

8. The power storage device according to claim 7, wherein the power storage device is flexible.

9. An electronic device comprising the power storage device according to claim 7.

10. An electrode comprising:
a current collector;
a conductive film over and in contact with the current collector; and
an active material layer over and in contact with the conductive film, the active material layer comprising a plurality of active material particles,
wherein a surface of the active material layer is rougher than the opposite surface of the active material layer.

11. The electrode according to claim 10, wherein the conductive film fills a depression on the surface of the active material layer.

12. The electrode according to claim 10, wherein the conductive film is thinner than the active material layer.

13. The electrode according to claim 10, wherein the active material layer comprises graphite.

14. The electrode according to claim 10, wherein the electrode is flexible.

15. The electrode according to claim 10, wherein a surface of the conductive film in contact with the current collector is rougher than a surface of the current collector in contact with the conductive film.

16. The electrode according to claim 10,
wherein the conductive film has a surface in contact with the active material layer and the opposite surface in contact with the current collector, and
wherein an area of the surface of the conductive film is larger than an area of the opposite surface of the conductive film.

17. The electrode according to claim 10,
wherein the active material layer further comprises an insulating particle,
wherein the active material layer comprises a first region and a second region,
wherein the first region comprises the insulating particle, and
wherein the first region is thicker than the second region.

18. A power storage device comprising the electrode according to claim 10.

19. The power storage device according to claim 18, wherein the power storage device is flexible.

20. An electronic device comprising the power storage device according to claim 18.
